(19) United States
(12) Patent Application Publication
(10) Pub. No.: US 2020/0410895 A1
(43) Pub. Date: Dec. 31, 2020

(54) LANGUAGE PRACTICE DEVICE, LANGUAGE TEACHING MATERIAL, AND LANGUAGE PRACTICE PROGRAM

(71) Applicant: Derek Yakiwchuk, Tokyo (JP)

(72) Inventor: Derek Yakiwchuk, Tokyo (JP)

(21) Appl. No.: 17/018,492

(22) Filed: Sep. 11, 2020

Related U.S. Application Data
(63) Continuation-in-part of application No. 15/746,691, filed on Jan. 22, 2018.

(30) Foreign Application Priority Data
Jul. 23, 2015 (JP) 2015-145488

(51) Int. Cl. G09B 19/06; G06F 3/16; G10L 15/22; G10L 15/19; G09B 7/08

(52) U.S. Cl. CPC G09B 19/06; G06F 3/167; G10L 15/187; G10L 15/19; G09B 7/08; G10L 15/22

(57) ABSTRACT

The present invention has an object to provide an opportunity of efficiently practicing a language to a language learner and to maintain motivation of the language learner. A display portion displays a bundle of language cards. On each card, information describing a conversation carried out between a teacher and a learner is written. A direction content card describes information that prescribes a conversation for determining a direction of a ball. A club content card describes information that prescribes a conversation for the learner to determine a type of a golf club. A club distance card describes information that prescribes a conversation for determining a carry of the ball. The teacher or the learner causes the language card to be displayed on the display portion and proceeds with the game based on displayed contents of the language card.

### CROSS-REFERENCE TO RELATED APPLICATIONS

This application is a continuation-in-part of and claims priority to U.S. patent application Ser. No. 15/746,691 (Attorney Docket No. DER-43779) entitled “LANGUAGE PRACTICE DEVICE, LANGUAGE TEACHING MATERIAL, AND LANGUAGE PRACTICE PROGRAM”, filed on Jan. 22, 2018; the entirety of the above-noted application(s) is incorporated by reference herein.

### TECHNICAL FIELD

The present invention relates to a language practice device, a language teaching material, and a language practice program and particularly to a device, a teaching material, and a program for providing an opportunity to use a language to a learner.

### BACKGROUND

Needs for learning a foreign language has been increased in many countries in the world. A foreign language learner practices conversations, reading, and writing of a foreign language in a school in many cases. A foreign language is practiced by using a communication medium such as the Internet, television, radio and the like or a recording medium such as a video disc, a compact disc and the like in some cases. In recent years, various foreign language education methods, foreign language practice devices, and foreign language teaching materials have been conceived of. For example, the following Patent Literatures 1 to 11 describe tools for practicing a foreign language.

### CITATION LIST

### Patent Literature

Patent Literature 1: U.S. Pat. No. 5,458,338

Patent Literature 2: U.S. Pat. No. 6,076,828

Patent Literature 3: U.S. Pat. No. 7,604,236

Patent Literature 4: U.S. Pat. No. 4,890,844

Patent Literature 5: U.S. Pat. No. 6,341,958

Patent Literature 6: U.S. Pat. No. 7,591,721

Patent Literature 7: U.S. Pat. No. 4,171,816

Patent Literature 8: U.S. Patent Laid-Open No. 2007/0015121

Patent Literature 9: U.S. Pat. No. 6,741,833

Patent Literature 10: U.S. Pat. No. 7,058,354

Patent Literature 11: U.S. Pat. No. 7,524,191

### BRIEF DESCRIPTION

### Technical Problem

In the foreign language practice tools described in the aforementioned Patent Literatures 1 to 11, consideration to provide an opportunity to efficiently practice a foreign language to a language learner and to maintain the motivation of the learner (motivation to learn) is lacking.

The present invention has an object to provide an opportunity to efficiently practice a language to a language learner and to maintain the motivation of the language learner.

### Solution to Problem

The present invention is characterized by including a question providing portion configured to provide a question to a learner in a language to be learned, an answer recognition portion configured to recognize an answer to the question, and an execution portion configured to execute a game based on the answer, and the execution portion executes element steps constituting the game based on a linguistic evaluation of the answer.

Preferably, the element step includes an advancing step for determining an advancing direction or an advancing distance of a piece used in the game based on the linguistic evaluation of the answer and a position determining step for determining a position of the piece in accordance with the advancing step, and the question providing portion provides a question element for determining the advance direction or a question element for determining the advancing distance as the question.

Moreover, the present invention is characterized by including a bundle of cards including a plurality of cards and a field on which a figure representing a progress state of the game is shown, and each of the cards describes a question to the learner or information for identifying the question to the learner determined in advance, and the question includes contents for executing the element steps constituting the game.

Preferably, the element steps include the advancing step for determining the advancing direction or the advancing distance of the piece on the field, and the question includes a question element for determining the advancing direction or the advancing distance.

Moreover, the present invention is characterized by having a computer executing question providing processing of providing a question to the learner in the language to be learned, answer recognition processing of recognizing the answer to the question, and execution processing of executing the game based on the answer, and the execution processing is processing of executing the element steps constituting the game based on the linguistic evaluation of the answer.

### Advantageous Effect of Invention

According to the present invention, an opportunity to efficiently practice a language can be provided to a language learner and the motivation of the language learner can be maintained.

The system keep language learners motivated by seamlessly using direction (e.g., direction component) and power of shot (e.g., club component) to control the character or ball on a surface. The questions and answers used in the direction component and club component utilizes many types of grammar, vocabulary, and phrases that can be utilized in the component. The language learner thereby has a way to practice language in both answering questions and making questions, which are necessary for language improvement. The club component and the shot component are the base of the language and shot cycle. The cycle is a collection of the fundamental language and grammar constructs necessary to become proficient in the language learning. Thereby, the learner can learn while playing and become proficient in language learning.

According to one aspect, a language practice device may include a question providing portion configured to provide a question to a learner in a language to be learned; an answer recognition portion configured to recognize an answer to the question; and an execution portion configured to execute a game based on a conversation process which is established by the question to the learner and the answer by the learner; and a display portion configured to display an image in accordance with each process executed by the question providing portion, the answer recognition portion, and the execution portion, wherein the question providing portion and the answer recognition portion perform: a process which proceeds a first conversation process for determining an advancing direction of a piece used in the game, and a process which proceeds a second conversation process for determining an advancing distance of the piece, the execution portion executes: a process which determines the advancing direction of the piece based on a linguistic evaluation of an answer in the first conversation process, a process which determines the advancing distance of the piece based on a linguistic evaluation of an answer in the second conversation process, and a process which determines a position of the piece in accordance with the advancing direction and the advancing distance, the display portion displays: a field for indicating a progress state of the game by the position of the piece, and a card selecting figure when the question providing portion provides the question, the question providing portion provides a question corresponding to a card selected by the learner on an image including the card selecting figure based on a predetermined success ratio and a mental fatigue score determined based on based on a length of a language learning session, and the execution portion executes the linguistic evaluation corresponding to the card selected by the learner on the image.

The language practice device may be configured such that the display portion displays images of a first bundle of cards and a second bundle of cards as the image of the card selecting figure, the display portion further displays an image indicating a front or a back of the card selected by the learner on the image, on each of the card included in the first bundle of cards, a question or information for progressing the first conversation process, which is a question to the learner or information for identifying a predetermined question to the learner, is described, on each of the card included in the second bundle of cards, a question or information for progressing the second conversation process, which is a question to the learner or information for identifying a predetermined question to the learner, is described, on each of the card included in the first bundle of cards, information for the linguistic evaluation in the first conversation process, is further described, and on each of the card included in the second bundle of cards, information for the linguistic evaluation in the second conversation process, is further described.

The language practice device may be configured such that the display portion displays an image of a bundle of cards as the image of the card selecting figure, the bundle of cards are common for the first conversation process and the second conversation process, the display portion displays an image indicating a front or a back of the card selected by the learner on the image, each of the card included in the bundle of cards describes, a question or information for progressing the first conversation process, which is a question to the learner or information for identifying a predetermined question to the learner, information for the linguistic evaluation in the first conversation process, a question or information for progressing the second conversation process, which is a question to the learner or information for identifying a predetermined question to the learner, and information for the linguistic evaluation in the second conversation process.

The language practice device may be configured such that the execution portion executes a process for setting a power to be given to the learner based on the progress state of the game, the question providing portion and the answer recognition portion execute a process for advancing a third conversation process established in business transaction, the third conversation process includes a question uttered by the learner in a case of purchasing a product according to the power and an answer uttered from a counterpart of the learner in the case of purchasing the product according to the power.

According to one aspect, a storage medium which stores a language practice program for making a computer may execute: a question providing process for providing a question to a learner in a language to be learned; an answer recognition process for recognizing an answer by the learner; an execution process for executing a game based on a conversation process which is established by the question to the learner and the answer by the learner; and an image generating process for generating an image in accordance with each of the question providing process, the answer recognition process, and the execution process, wherein the question providing process and the answer recognition process configures, a process which proceeds a first conversation process for determining an advancing direction of a piece used in the game, and a process which proceeds a second conversation process for determining an advancing distance of the piece, the execution process includes, a process which determines the advancing direction of the piece based on a linguistic evaluation of an answer in the first conversation process, a process which determines the advancing distance of the piece based on a linguistic evaluation of an answer in the second conversation process, and a process which determines a position of the piece in accordance with the advancing direction and the advancing distance, the image generating process includes a process for generating a field image for indicating a progress state of the game by the position of the piece, and a process for generating an image of a card selecting figure, which is a process executed when providing the question in the question providing process, the question providing process includes a process for providing a question corresponding to a card selected by the learner on the image including the card selecting figure based on a predetermined success ratio and a mental fatigue score determined based on based on a length of a language learning session, and the execution portion includes a process for executing the linguistic evaluation corresponding to the card selected by the learner on the image.

### BRIEF DESCRIPTION OF THE DRAWINGS

FIG. 1 is a view illustrating a foreign language practice device according to an embodiment of the present invention.

FIG. 2 is a view illustrating an example of a game field and a piece displayed on a display portion.

FIG. 3 is a view illustrating an example of an image displayed on the display portion during progress of a golf game.

FIG. 4A is a view illustrating an example of a direction content card displayed on the display portion.

FIG. 4B is a view illustrating an example of a club content card displayed on the display portion.

FIG. 4C is a view illustrating an example of a club distance card displayed on the display portion.

FIG. 5 is a view illustrating processing executed by the foreign language practice device for a learner.

FIG. 6 is a view exemplifying a selected language card and game progress state.

FIG. 7 is a view illustrating an example of conversation carried out by using each of the language cards.

FIG. 8 is a view exemplifying an evaluation sheet.

FIG. 9 is a view exemplifying a flow of the conversation when an OK question card is added in addition to the direction content card and club content card.

FIG. 10 is a view illustrating an example in which two parts of conversion are carried out in comparison with one part of conversation.

FIG. 11A is a view illustrating a plurality of types of questions illustrated by the direction content card and the club content card.

FIG. 11B is a view illustrating a plurality of types of questions illustrated by the direction content card and the club content card.

FIG. 11C is a view illustrating a plurality of types of questions illustrated by the direction content card and the club content card.

FIG. 11D is a view illustrating a plurality of types of questions illustrated by the direction content card and the club content card.

FIG. 12 is a view illustrating a variation of the questions.

FIG. 13 is a view illustrating an example of a complex cards used in a one-card game.

FIG. 14 is a flowchart of the golf game.

FIG. 15 is a view illustrating a play surface as the game field.

FIG. 16 is a flowchart of a language and shopping cycle.

FIG. 17A is a view illustrating an example of a course design.

FIG. 17B is a view illustrating an example of the course design.

FIG. 18 is an illustration of an example computer-readable medium or computer-readable device including processor-executable instructions configured to embody one or more of the provisions set forth herein, according to one aspect.

FIG. 19 is an illustration of an example computing environment where one or more of the provisions set forth herein are implemented, according to one aspect.

FIG. 20 is a flowchart of the game.

FIG. 21 is a view illustrating a plurality of types of questions associated with a content card for ordering coffee.

FIG. 22 is a view illustrating a plurality of types of questions associated with a content card for making a purchase.

FIG. 23 is a view illustrating a plurality of types of questions associated with a content card for planning a meeting.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

### DESCRIPTION OF EMBODIMENT

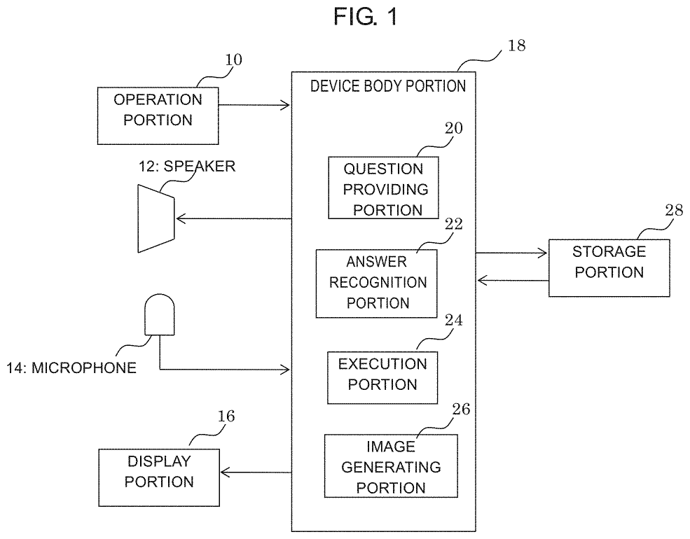

FIG. 1 illustrates a foreign language practice device according to an embodiment of the present invention. The foreign language practice device promotes a conversation between a teacher and a learner and carries out the conversation with the learner by voice recognition processing. The foreign language practice device proceeds with a game in accordance with an evaluation result of the conversation input by the teacher or the evaluation result by the device itself. The foreign language practice device includes a device body portion 18, a storage portion 28, an operation portion 10, a speaker 12, a microphone 14, and a display portion 16. The device body portion 18 includes an electric circuit for connecting the operation portion 10, the speaker 12, the microphone 14, and the display portion 16. The operation portion 10 may include an input device such as a mouse, a keyboard, a trackball, and the like. The display portion 16 includes a device such as a display and the like for displaying an image. The display portion 16 may be a touch screen including a static capacitance sensor as a part of the operation portion 10. Moreover, the display portion 16 may be a device for projecting a hologram.

The device body portion 18 is constituted by a computer. The device body portion 18 executes the following processing based on a foreign language practice program stored in the storage portion 28. That is, the device body portion 18 displays a question in a foreign language on the display portion 16 in accordance with an operation in the operation portion 10. The teacher reads out the displayed question, and the learner answers to the question in a voice. The teacher evaluates fluentness, accuracy and the like of the answer and inputs the evaluation results into the device body portion 18 by the operation of the operation portion 10. The evaluation of fluentness of the answer includes smoothness of pronunciation and the like other than a speed of the answer. As discussed below, the execution portion or the operation portion 10 may evaluate the fluentness of the answer, the smoothness of the answer, and the pronunciation of the answer based on a native language of the language learner. Thus, if a French language learner is learning English he or she may not be penalized for having a French accent when pronouncing a word of a phrase. The device body portion 18 may recognize the voiced detected by the microphone 14 and determine the native language of the language user based on the accent of the answer or based on other speech received. The device body portion 18 proceeds with the game in accordance with the evaluation result.

Here, instead of the question and evaluation by the teacher, the device body portion 18 may carry out the question and evaluation based on the execution of the foreign language practice program. That is, the device body portion 18 outputs a question from the speaker 12 in accordance with the operation in the operation portion 10. The learner answers to the question by voice. The device body portion 18 recognizes the voiced detected by the microphone 14, evaluates fluentness, accuracy and the like of the answer, and proceeds with the game in accordance with the evaluation result. In a progress of the game, the device body portion 18 displays guidance information to the learner or the teacher and the progressing state of the game on the display portion 16.

The game is played by using a game field illustrating figures such as a start, a goal, a course, and the like as figures for indicating the advancing state. For example, it is assumed that a piece placed on the game field is moved only for a direction and a distance according to the evaluation result each time the conversation is evaluated so that the piece should reach the goal by as less conversation as possible. Such a game includes a golf game, for example. The game field and the piece may be provided as real objects separately from the foreign language practice device or may be displayed as an image on the display portion 16. If the game field is to be real, the game field may be formed in a sheet state by paper, vinyl, rubber or the like or may be formed in a board state by plastic, wood or the like. The game field may be a magnet board, a cork board, a white board, a blackboard and the like.

Constitution of the device body portion 18 and processing executed by the device body portion 18 may be described. A processor included in the device body portion 18 constitutes a question providing portion 20, an answer recognition portion 22, an execution portion 24, and an image generating portion 26 based on a foreign language practice program stored in the storage portion 28. The question providing portion 20 generates question information based on the operation performed in the operation portion 10. And the question is displayed on the display portion 16 or the question is output from the speaker 12. The answer recognition portion 22 recognizes the answer based on a character input from the operation portion 10 or recognizes the voice detected by the microphone 14 as the answer. The execution portion 24 acquires a position of the piece on the game field based on the answer recognized by the answer recognition portion 22. The image generating portion 26 generates image data according to the progress state of the game and displays an image based on the image data on the display portion 16.

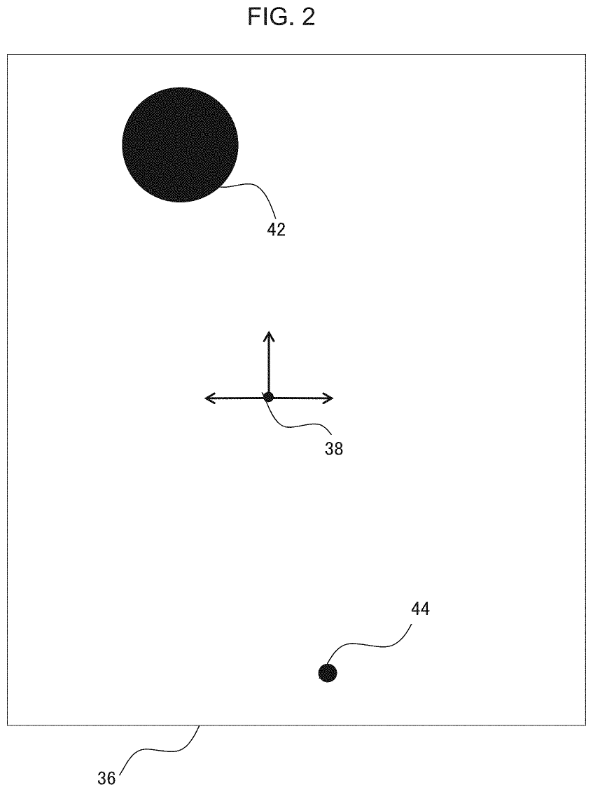

FIG. 2 illustrates an example of a game field 36 and a piece 38 displayed on the display portion 16 during the progress of the game. On the game field 36, a plurality of piece arrangement points is set. In the example illustrated in FIG. 2, a lattice by a plurality of vertical lines drawn in parallel and a plurality of lateral lines drawn in parallel is drawn. One cell in the lattice indicates one piece arrangement point.

When the game is played, first, the piece 38 is placed at a start position 44. Then, each time the conversation is evaluated, the piece 38 is moved only for a direction and a distance (the number of piece arrangement points) according to the evaluation result. A goal region 42 is a region including a plurality of the piece arrangement points. With the conversation and its evaluation, the piece 38 is moved on the game field 36. When the piece 38 enters the goal region 42, the game is finished. When a plurality of the learners play the game, a learner who has his/her piece 38 reach the goal region 42 with the smallest number of conversation times wins the game. Moreover, such a rule may be determined that with the smaller number of conversation times the piece 38 is made to reach the goal region 42, the higher points can be gained so that the game can be enjoyed regardless of the number of the learners.

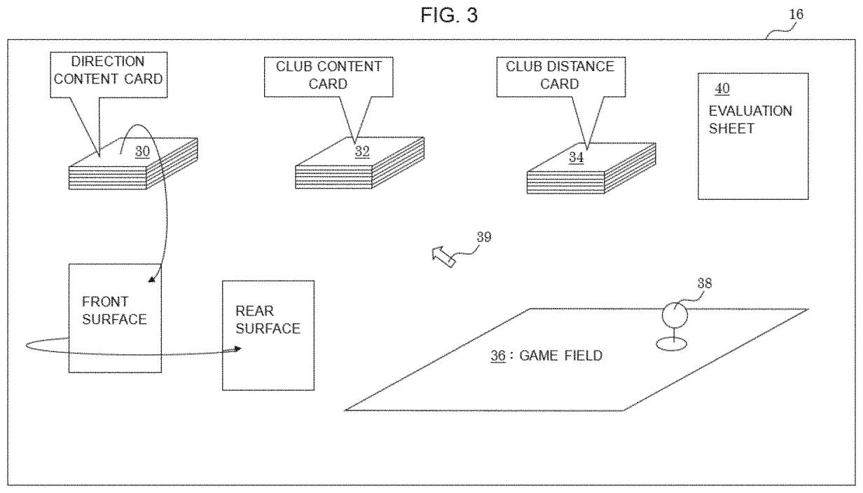

FIG. 3 illustrates an example of an image displayed on the display portion 16 during the progress of the golf game. The display portion 16 displays a bundle of direction content cards 30, a bundle of club content cards 32, and a bundle of club distance cards 34 as bundles of language cards. Each card describes information regulating the conversation carried out between the teacher and the learner. That is, the direction content card 30 describes the information regulating the conversation for determining a direction of a ball. The club content card 32 describes the information regulating the conversation for the learner to determine a type of a golf club. The club distance card 34 describes the information regulating the conversation for determining a ball distance of the ball. For example, on a front of each card, a question read out by the teacher and options of the answer are described, while on a back of each card, information which becomes a guideline for evaluation of the answer by the teacher is described. Description contents of each language card may be described later.

Selection and display of the language card are carried out as follows, for example. That is, a click by a mouse is made in a state where a cursor 39 is matched with the bundle of language cards in a display state, and the front side of the language card is displayed on the display portion 16. In a state where the cursor 39 is matched with the language card and in the display state, when a click by a mouse is further made, the rear side of the language card is displayed on the display portion 16. The teacher and the learner proceed with the game based on display contents of the language card. If the display portion 16 is a touch screen, the selection or the like of the language card is made by contact with a finger of the learner or the teacher instead of a click by the mouse.

If the device body portion 18 in FIG. 1 outputs a question from the speaker 12 and recognizes the answer based on the voice detected by the microphone 14 (hereinafter referred to as voice generation/recognition processing), the operation for selecting the language card is carried out and the device body portion 18 outputs the question from the speaker 12, and recognizes the answer through the microphone 14. In this case, the front and the back of the language card do not have to be displayed on the display portion 16.

On the display portion 16, the game field 36 and the piece 38 are displayed. Here, the piece 38 is a ball. The game field 36 and the piece 38 may be displayed in another window as in FIG. 2.

On an evaluation sheet 40, an evaluation result made for each conversation is described (marked). This description may be made by the operation by the teacher or may be made by the device body portion 18. As may be described later, the direction or ball distance of the ball as the piece 38 may be influenced in accordance with the evaluation result.

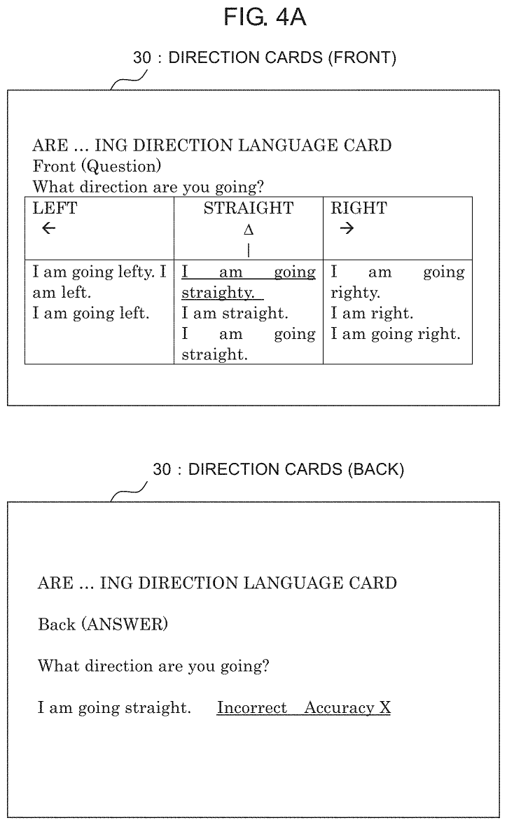

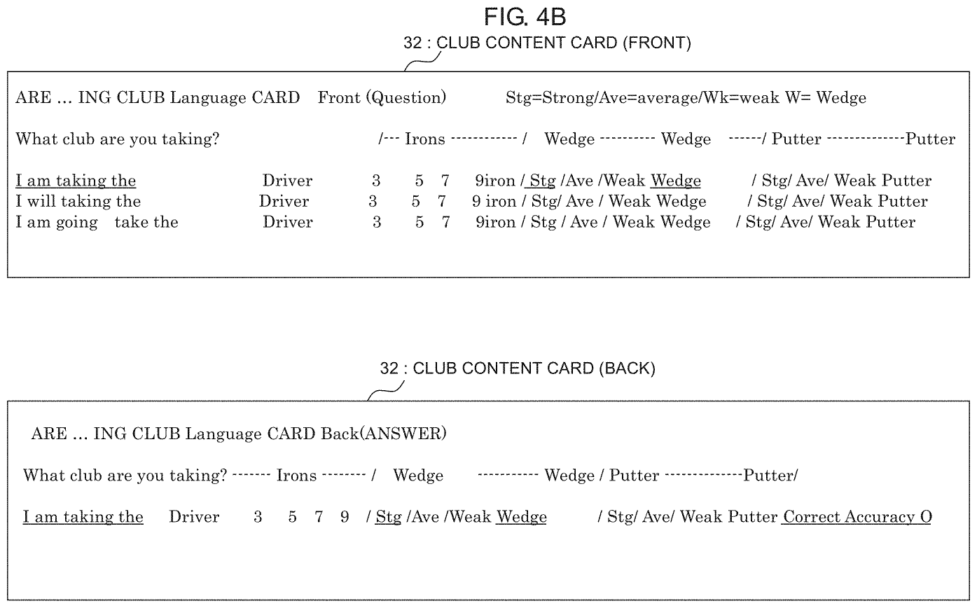

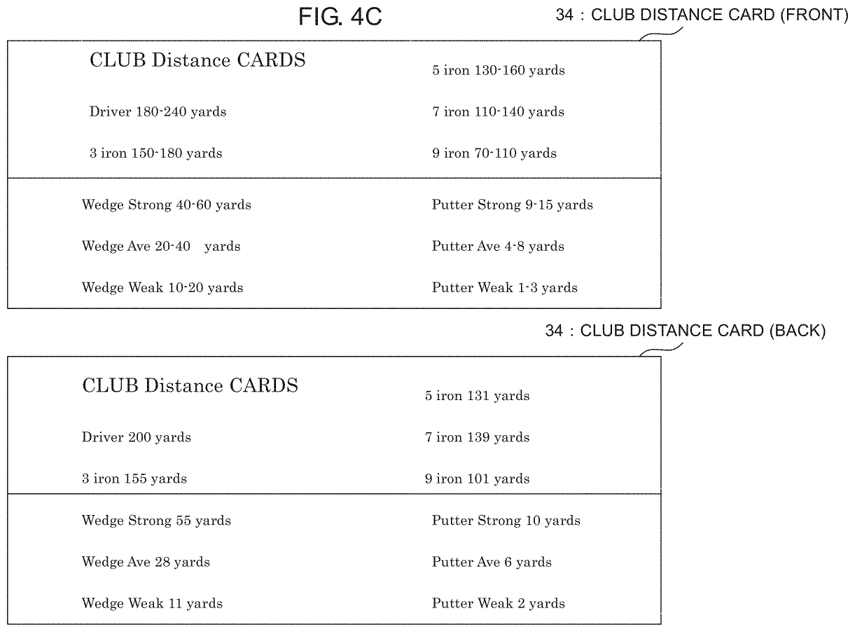

FIG. 4A illustrates an example of the direction content card displayed on the display portion 16. On the front of the direction content card, an English sentence “What direction are you going?” is described as an interrogative sentence for asking a direction in a form of “are - - -ing” and this is read out by the teacher. Below that, a plurality of answer options is described. The underlined option of them indicates selection by the operation of the teacher who heard the answer of the learner. On the back, an English sentence “I am going straight.” is described as an example of a correct answer and is referred to by the teacher. Here, the answer by the learner “I am going straighty.” is wrong. Thus, on the back of the direction content card, it is indicated that the learner's answer is wrong by the English sentence “Incorrect Accuracy X” based on the operation by the teacher. Through the conversation using the direction content card, the direction of the ball is determined.

When the device body portion 18 executes the voice generation/recognition processing, before and during the conversation, it may be configured that the front and the back of the direction content card are not displayed. And the front or the back of the direction content card may be displayed after one round of conversation has been made. In this case, the underlined portion in the description on the direction content card may be displayed by the processing of the device body portion 18.

FIG. 4B illustrates an example of the club content card displayed on the display portion 16. On the front of the club content card, an English sentence “what club are you taking?” is described as an interrogative sentence for asking the golf club to be used in the form of “are - - -ing” and this is read out by the teacher. On the right thereof, a plurality of answer options is described. The options are a driver, a No. 3 iron, a No. 5 iron, a No. 7 iron, a strong wedge, an average wedge, a weak wedge, a strong putter, an average putter, and a weak putter, and any one of them is to be selected in accordance with the English sentence described on the left of these options. The underlined option indicates selection by the operation of the teacher who heard the answer of the learner. On the back, an English sentence “I am taking the - - - -” is described as an example of a correct answer and is referred to by the teacher. Here, the answer by the learner “I am taking the Strong Wedge.” is correct. Thus, on the back of the club content card, it is indicated that the learner's answer is correct by the English sentence “Correct Accuracy 0” based on the operation by the teacher. Through the conversation using the club content card, the type of the golf club to be used by the learner is determined.

When the device body portion 18 executes the voice generation/recognition processing, before and during the conversation, it may be configured that the club content card is not displayed. And the club content card may be displayed after one round of conversation has been made. In this case, the underlined portion in the description on the club content card may be displayed by the processing of the device body portion 18.

FIG. 4C illustrates an example of the club distance card displayed on the display portion 16. The club distance card is a card associating the ball distance with the golf club selected by the club content card. The front of the club distance card illustrates that it is a card to 11 types of the golf clubs, that is, the driver, the No. 3 iron, the No. 5 iron, the No. 7 iron, the strong wedge, the average wedge, the weak wedge, the strong putter, the average putter, and the weak putter. On the back of the club distance card, the ball distance is indicated such as “Driver 200 yards”. By means of the club distance card, the ball distance corresponding to the golf club used by the learner is determined. Here, the club distance card collecting the carries for the 11 types of golf clubs is taken up, but the club distance card may be created for each golf club. In this case, 11 bundles of the club distance cards are created.

The contents of the direction content card, the club content card, and the club distance card are stored in the storage portion 28 and are read out as appropriate by the device body portion 18. A question in each card may be a solicitation-type question. The solicitation-type question includes “Why don't you go right?”, “How about going right?”, “Why don't you use the 2 iron?”, “How about using the 2 iron?”, “How do you feel about using the 2 iron” and the like.

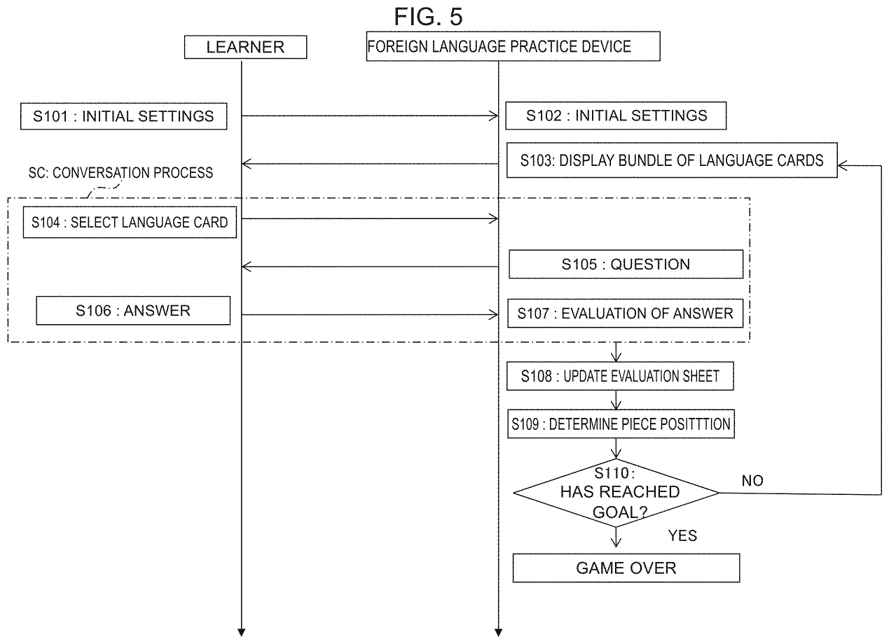

FIG. 5 illustrates a sequence chart of the processing executed by the foreign language practice device for the learner. Here, it is assumed that the device body portion included in the foreign language practice device executes the voice generation/recognition processing.

First, the learner carries out initial setting of the foreign language practice device by the operation on the operation portion (S101 and S102). The initial setting includes setting of an area of the goal region, initialization of the contents of the evaluation sheet and the like. The foreign language practice device displays the bundle of each language card on the display portion (S103).

The learner selects the language card displayed on the display portion by operating the operation portion (S104). This selection is made by clicking by a mouse in a state where the cursor is placed on the language card, for example, if the operation portion includes the mouse. The direction content card, the club content card, and the club distance card are selected in this order in repetition of a conversation process (SC) which may be defined later, but at Step (S104), one of these language cards is selected.

The foreign language practice device outputs the question from the speaker in accordance with the selected language card (S105). The learner answers aloud to the question emitted from the speaker (S106). The foreign language practice device recognizes the voice detected by the microphone and evaluates fluentness, accuracy and the like of the answer (S107). The fluentness includes quickness of the answer and smoothness of pronunciation. The evaluation of the quickness of answer is made by time measured from emission of the question from the speaker until the answer is completed by a timer included in the device body portion 18, for example. Moreover, fluentness (quickness of the answer and smoothness of pronunciation), accuracy, and the like may be evaluated based on recognized voice data indicating the voice recognized through the microphone and a degree of approximation to standard voice data stored in the storage portion in advance. In this case, the timer does not have to be used. The degree of approximation between the recognized voice data and the standard voice data can be acquired based on a correlation value between a temporal waveform indicated by the recognized voice data and the temporal waveform indicated by the standard voice data, for example.

The conversation process (SC) including the selection of the language card (S104), the question (S105), the answer (S106), and the evaluation of the answer (S107) is repeated until a plurality of the answers required for determining the position of the piece at the subsequent Step S108 is acquired.

If the game is a golf game, for example, the position of the piece is determined by three conversation processes, that is, the conversation process when the direction content card is selected as the language card, the conversation process when the club content card is selected as the language card, and the conversation process when the club distance content card is selected as the language card.

The foreign language practice device updates the evaluation sheet by reflecting each of the evaluation results in the evaluation sheet (S108). Moreover, the foreign language practice device determines the position of the piece based on the contents of each answer and each evaluation result (S109). For example, if the game is a golf game, determination of the position of the ball as a piece is made based on the direction content card, the club content card, and the club distance content card used in the conversation process. That is, by means of the conversation using these language cards, the direction of the ball and the carry according to the selected golf club are determined, and the position of the ball is determined. As may be described later, a change may be added to the direction and the carry of the ball based on each evaluation result in the conversation process.

When the position of the piece is determined at Step S109 in FIG. 5, the foreign language practice device may execute processing as follows. That is, the foreign language practice device sets an optimal course from the position of the piece 38 at the current point of time in FIG. 2 to the goal region 42. The optimal course is a straight line, for example. When the evaluation in the conversation process is good, a new position of the piece 38 is determined along the optimal course, while if the evaluation in the conversation process is not good, a new position of the piece 38 is determined at a position deviated from the optimal course.

The foreign language practice device determines whether the piece on the game field has reached the goal region or not (S110). If the piece has not reached the goal region, the foreign language practice device returns to the processing at Step S103 and displays each bundle of language cards on the display portion. On the other hand, when the piece has reached the goal region, the foreign language practice device ends the game.

As described above, the device body portion 18 included in the foreign language practice device illustrated in FIG. 1 includes the question providing portion 20 configured to provide a question to the learner in the language to be learned, the answer recognition portion 22 for recognizing the answer to the question, and the execution portion 24 for executing the game based on the answer. The execution portion 24 executes element steps constituting the game based on linguistic evaluation such as fluentness, accuracy and the like of the answer. The element step includes an advancing step for determining a direction (advance direction) of the piece based on the linguistic evaluation of the answer, and the advancing step for determining the ball distance (advance distance) according to the golf club based on the linguistic evaluation of the answer. Moreover, the element step includes a position determining step for determining the position of the piece in accordance with the advancing step. The question providing portion 20 provides a question element for determining the advancing direction or a question element for determining the advancing distance as a question based on the description of the language card.

Here, at Step S107, the example in which the fluentness of the answer (quickness or smoothness of pronunciation) and the accuracy are evaluated was described. The evaluation may be made for at least any one of the quickness of the answer, the smoothness of the pronunciation, and the accuracy.

Moreover, the foreign language practice device may constitute a game in which one of the plurality of learners plays a role of the teacher, and the plurality of the learners including the learner playing the role of the teacher compete with each other. In this case, at least any one of the quickness, smoothness of pronunciation, and accuracy may be evaluated also for the question of the learner playing the role of the teacher. For example, options of expression for the question by the learner with the role of the teacher are described on the fronts of the direction content card and the club content card. On the backs of these cards, which of the options is correct is illustrated so that the evaluation can be made for the question made by the learner with the role of the teacher.

Moreover, by setting the number of options described on the front of each card to two and by indicating which of the two options is correct on the back, an alternative-type test (T/F test) may be carried out. Moreover, on the front of each card, a question in a form filling a blank, a question in a form to find an error, a question in a form of selecting a correct expression and the like may be described.

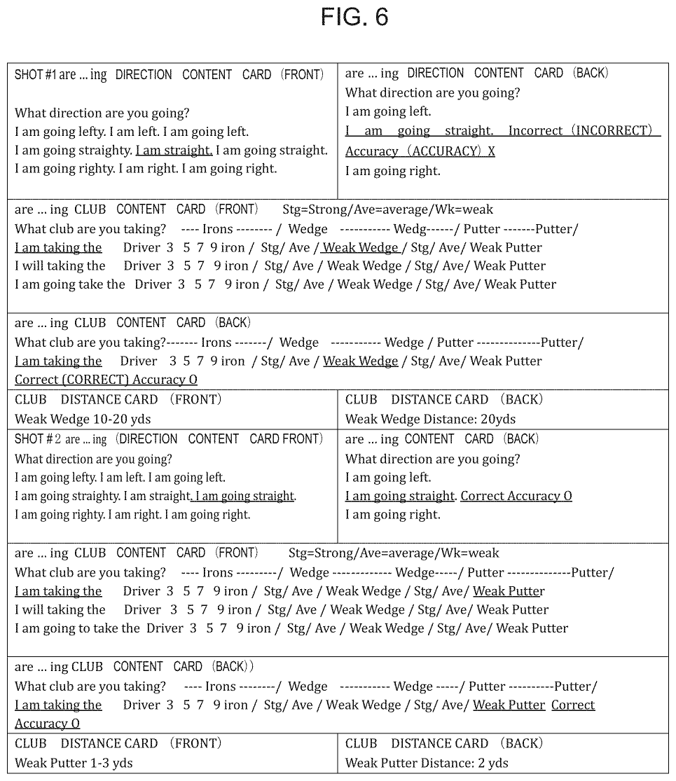

FIG. 6 exemplifies the language card selected at two shots #1 and #2 and a game progress situation. On the front of the direction content card at the first shot #1, a question “what direction are you going?” is illustrated, and a fact that an answer “I am straight.” was made is illustrated. The back of the direction content card illustrates that a correct answer is “I am going straight.” and the selected answer is wrong. On the front of the club content card at the first shot #1 illustrates that a question “what club are you taking?” was made and an answer “I am taking the Weak Wedge” was made. The back of the club content card illustrates that the answer is correct. On the back of the club distance card at the first shot #1 describes “Weak Wedge Distance: 20 yds”, which illustrates that the ball distance of a weak wedge is 20 yards. In this way, at the first shot #1, it is determined that the ball flies straight for the carry of 20 yards.

For the second shot #2, too, the similar game progress state is exemplified. That is, the front of the direction content card at the second shot #2 illustrates that a question “What direction are you going?” was made, and an answer “I am going straight.” was made. The back of the direction content card illustrates that the correct answer is “I am going straight.” and the selected answer is correct. The front of the club distance card at the second shot #2 illustrates that a question “What club are you taking?” is made and an answer “I am taking the Weak Putter.” was made. The back of the club content card illustrates that the answer is correct. The back of the club content card at the second shot #2 describes that “Weak Putter Distance 2 yds” and illustrates that the carry of the weak putter is 2 yards. In this way, at the second shot #2, it is determined that the ball flies straight for the carry of 2 yards.

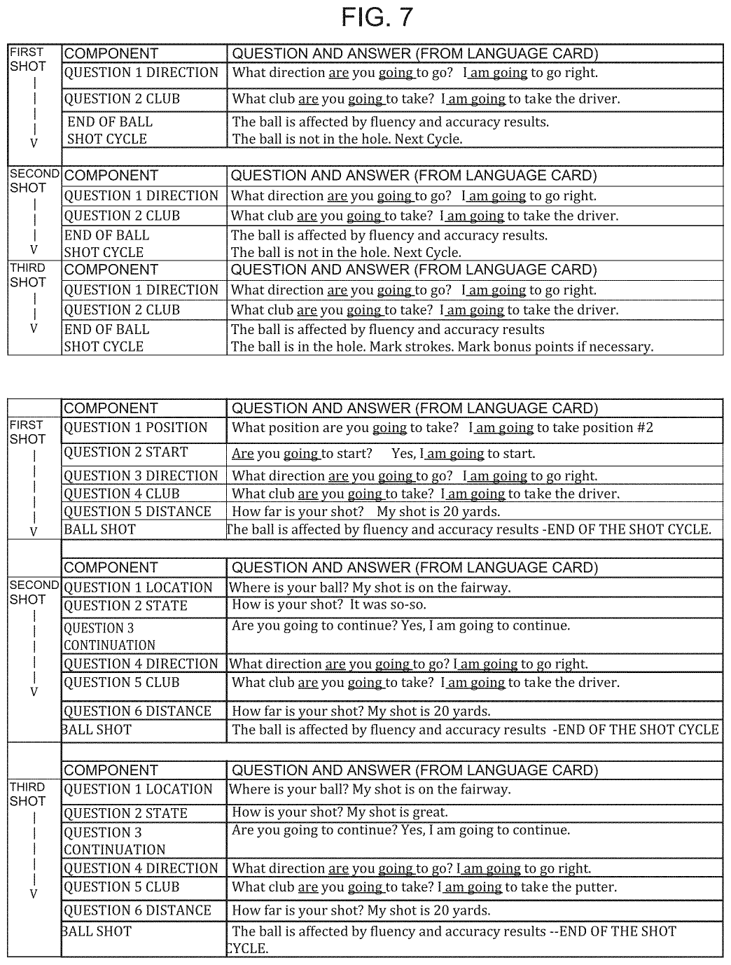

On an upper side in FIG. 7, a conversation using the direction content card “What direction are you going to go?”, “I am going to go right.” and a conversation using the club content card “what club are you going to take?”, “I am going to take the driver.” are shown. On a lower side in FIG. 7, types of cards are added, and an example in which conversations on a position, start, location, a state, continuation or not and a ball distance is carried out is shown. As a conversation on the position, “What position are you going to take?”, “I am going to take position #2.” are shown. As a conversation on the start, “Are you going to start?”, “Yes, I am going to start.” are shown. As a conversation on the location, “Where is your ball?”, “My shot is on the fairway.” are shown. As a conversation on the state, “How is your shot?”, “It was so-so.” are shown. As a conversation on whether or not to continue, “Are you going to continue?”, “Yes, I am going to continue.” are shown. As a conversation on the carry, “How far is your shot?”, “My shot is 20 yards.” are shown.

There are various other conversations on start. For example, if the present invention is applied to a baseball game, the game may be started by an expression “Are you going to pitch/hit?” Moreover, if the learner's intention to start is clear, the game can be started by an expression “Are you going to start?” or an expression “Will you move?” Furthermore, the game may be started by a general expression “What are you going to do?”

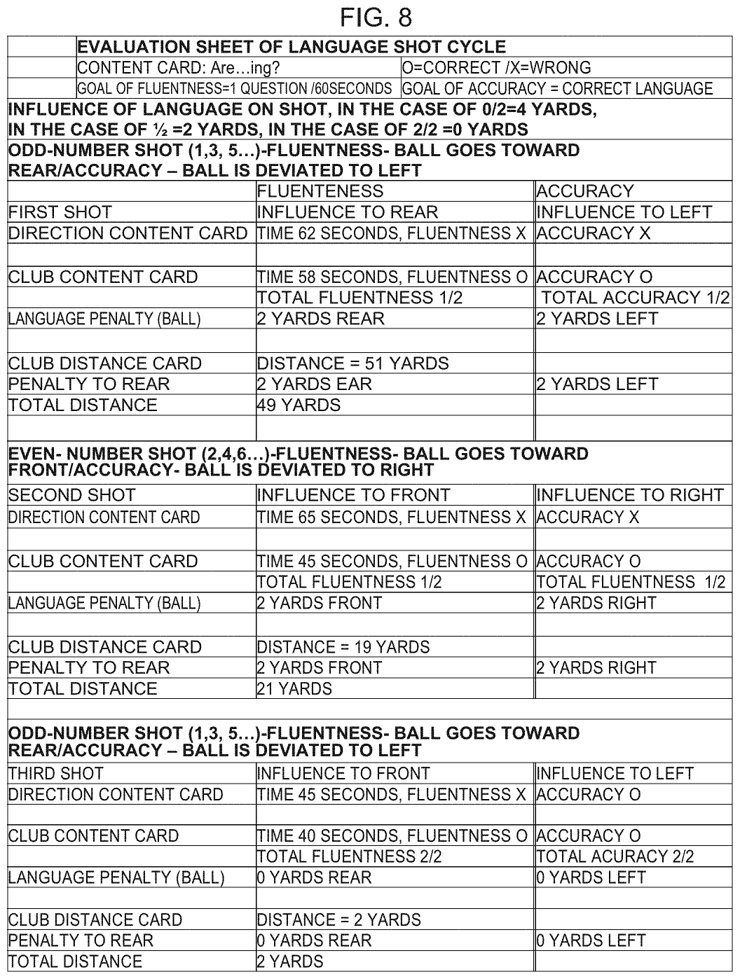

FIG. 8 exemplifies an evaluation sheet. This evaluation sheet applies a change to the direction and the carry of the ball determined in accordance with each language card based on each evaluation result in the conversation process and gives an influence on them. This evaluation sheet is used when the position of the piece is determined at Step S109 in FIG. 5, for example.

In the answer, the fluentness and accuracy are evaluated as linguistic evaluation items. To answer one question within 60 seconds is considered to be a goal of the fluentness. Moreover, to be correct in terms of widely used customary expressions, idioms, the grammar and the like is considered to be a goal of accuracy. Moreover, proficiency to use polite expression or euphemism with “would”, “could”, “might” and the like may also be evaluated.

At an odd numbered shot, a change is added so that the ball is moved rearward due to a low evaluation of the fluentness. Moreover, a change is added so that the ball is moved to the left by the low evaluation of accuracy. At an even numbered shot, a change is added so that the ball goes to the front by the low evaluation of the fluentness. Moreover, a change is added so that the ball is moved to the right by the low evaluation of accuracy.

Specifically, in two types of conversation by the direction content card and the club content card, if an “X” mark representing rejection is given twice to the fluentness, the ball is moved to the front or to the rear only by 4 yards as a penalty. Moreover, if the “X” mark representing rejection is given once to the fluentness, the ball is moved to the front or to the rear only by 2 yards as a penalty.

In two types of conversation by the direction content card and the club content card, if the “X” mark representing rejection is given twice to the accuracy, the ball is moved to the right or to the left only by 4 yards as a penalty. Moreover, if the “X” mark representing rejection is given once to the accuracy, the ball is moved to the right or to the left only by 2 yards as a penalty.

If there is no “X” mark representing rejection for either of fluentness and accuracy, the direction and the ball distance of the ball determined based on the conversation according to each language card are not changed.

For example, at the first shot, the learner requires 62 seconds to answer according to the direction content card. Since this is longer than the goal of 60 seconds, the evaluation of fluentness is the “X” mark as rejection. Moreover, the learner is given the evaluation of the “X” mark as rejection for the answer according to the direction content card. Furthermore, the learner requires 58 seconds for the answer according to the club content card. Since this is not longer than the goal of 60 seconds, the evaluation of the fluentness is an “O” mark as passing. Moreover, the learner is given the evaluation of the “O” mark as passing for the answer according to the club content card.

Therefore, there is one rejection for the fluentness, and the ball is moved to the rear only by 2 yards. The carry of the ball determined based on the conversation according to each language card should have been 51 yards, but the movement to the rear by the 2 yards makes 49 yards. There is one rejection for the accuracy, and the ball is moved to the left only by 2 yards.

At the second shot, the learner requires 65 seconds to answer according to the direction content card. Since this is longer than the goal of 60 seconds, the evaluation of fluentness is the “X” mark as rejection. Moreover, the learner is given the evaluation of the “X” mark as rejection for the answer according to the direction content card. Furthermore, the learner requires 45 seconds for the answer according to the club content card. Since this is not longer than the goal of 60 seconds, the evaluation of the fluentness is the “O” mark as passing. Moreover, the learner is given the evaluation of the “O” mark as passing for the answer according to the club content card.

Therefore, there is one rejection for the fluentness, and the ball is moved to the front only by 2 yards. The carry of the ball determined based on the conversation according to each language card should have been 19 yards, but the movement to the front by the 2 yards makes 21 yards. There is one rejection for the accuracy, and the ball is moved to the right only by 2 yards.

At the third shot, the learner requires 45 seconds to answer according to the direction content card. Since this is not longer than the goal of 60 seconds, the evaluation of the fluentness is the “O” mark as passing. Moreover, the learner is given the evaluation of the “O” mark as passing for the answer according to the direction content card. Furthermore, the learner requires 40 seconds for the answer according to the club content card. Since this is not longer than the goal of 60 seconds, the evaluation of the fluentness is the “O” mark as passing. Moreover, the learner is given the evaluation of the “O” mark as passing for the answer according to the club content card.

Therefore, since there is no rejection “X” for either of the fluentness and the accuracy, the direction and the carry of the ball determined in accordance with each language card are not changed. The carry of the ball determined in accordance with each language card is 2 yards, and the game is proceeded with as it is.

As described above, the direction and the carry of the ball are determined in accordance with the evaluation on the answer by the learner in the game, and the evaluation of the answer by the learner can give an advantageous or disadvantageous influence to the learner. It is not necessary to reflect all the evaluations in the ball direction or carry. For example, at least either one of the fluentness (quickness and smoothness) and the accuracy may be reflected in the ball direction or carry. Moreover, the evaluation on the answer may be reflected in the ball direction or carry only for the odd-numbers shots, the odd-numbered shots, or each shot. Since the memorization and gaming are brought together the learner is more motivated to learn. Also, this device is novel because gameplay and language use are perfectly integrated. They cannot be separated, thereby the learning process through the computer is more intuitive than in previous learning programs.

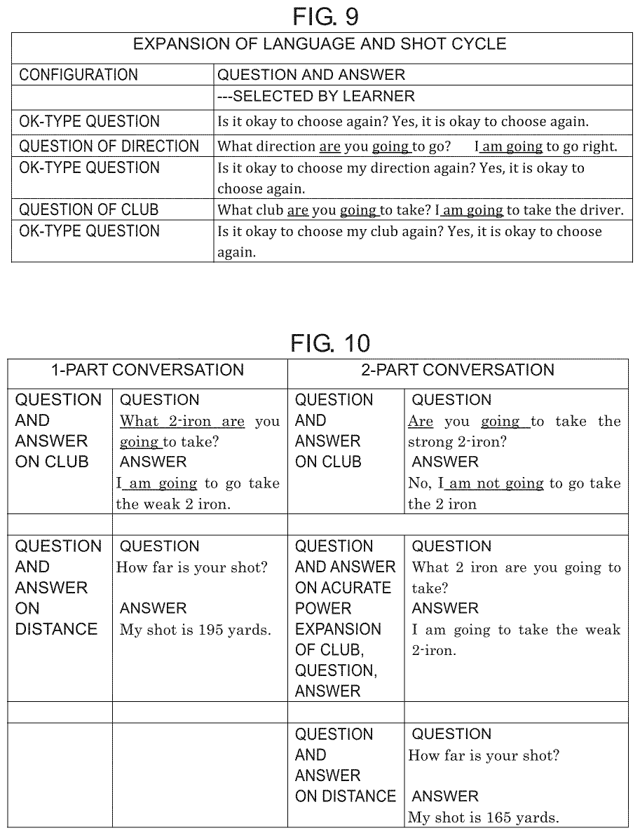

FIG. 9 illustrates a flow of the conversations when an OK question card is added to the direction content card and the club content card. The OK question card determines a conversation for re-selection of the direction content card or the club content card between the learner and the teacher or between the learner and the foreign language practice device. The OK question card is selected after the direction content card or after the club content card. On the front of the OK question card, an English sentence for checking the selection by the learner of the language card is described such that “Is it okay to choose my direction again?” On the back of the OK question card, an English sentence answered by the teacher or the foreign language practice device on the check contents is described such that “Yes, it is okay to choose again.”

In the above, the example in which the cards are selected in the order of the direction content card, the club contents, and club distance cards was described. Each language card may be divided into a plurality of questions and answers. FIG. 10 illustrates an example in which, in comparison to a 1-part conversation based on the one type of the club content card, a 2-part conversation by the two types of the club content cards are carried out. In this example, the club content card is divided into two types, and the 2-part conversation is carried out by the two types of the club content cards. In the game, the bundle of the first type of the club content cards and the bundle of the second type of the club content cards are provided.

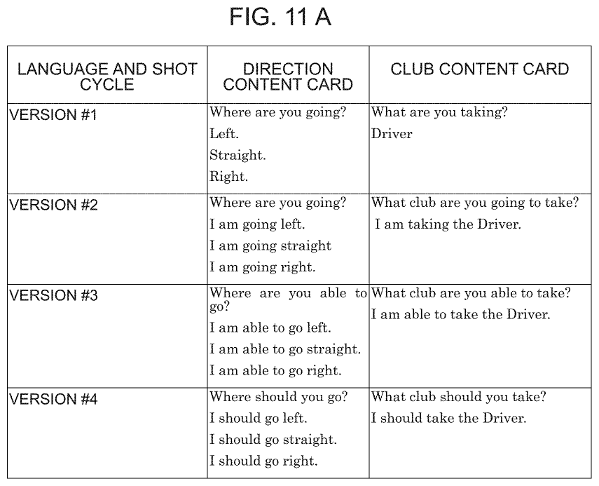

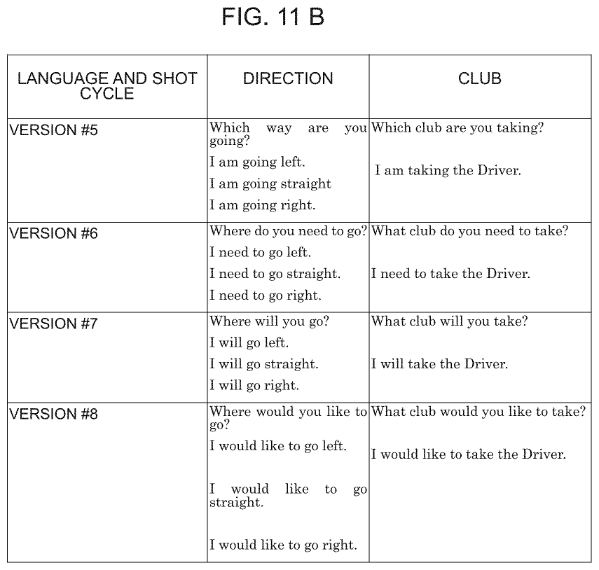

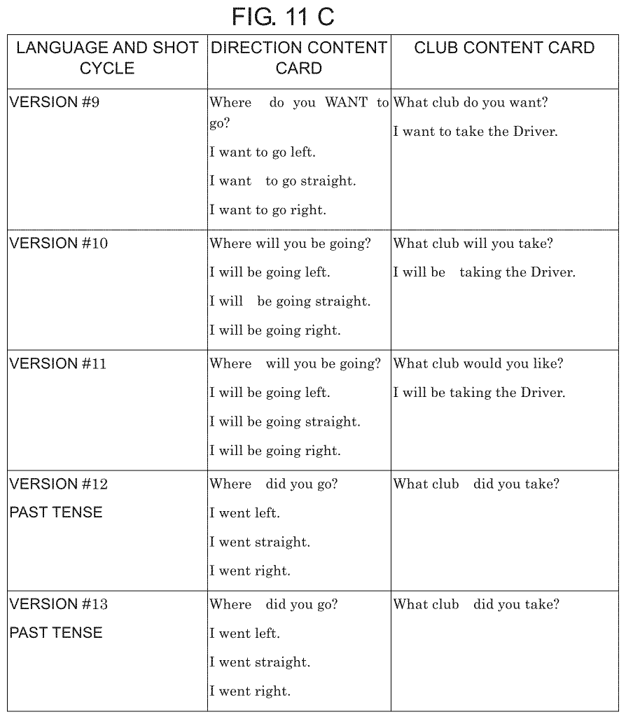

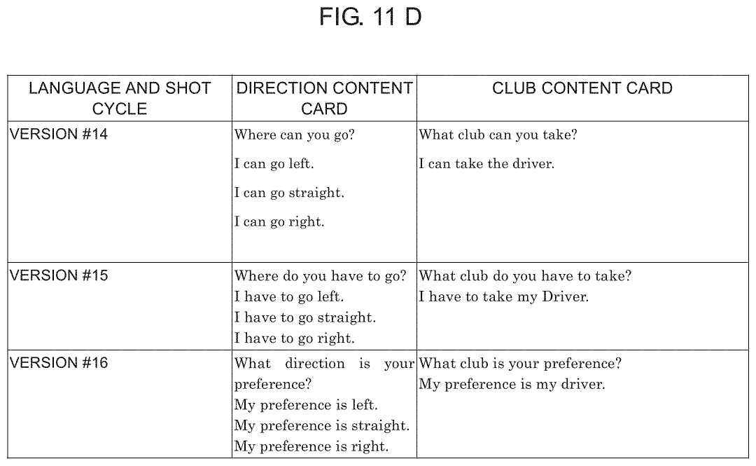

In FIGS. 11A, 11B, 11C, and 11D, a plurality of questions illustrated by the direction content card and the club content card are illustrated as a version #1 to a version #16.

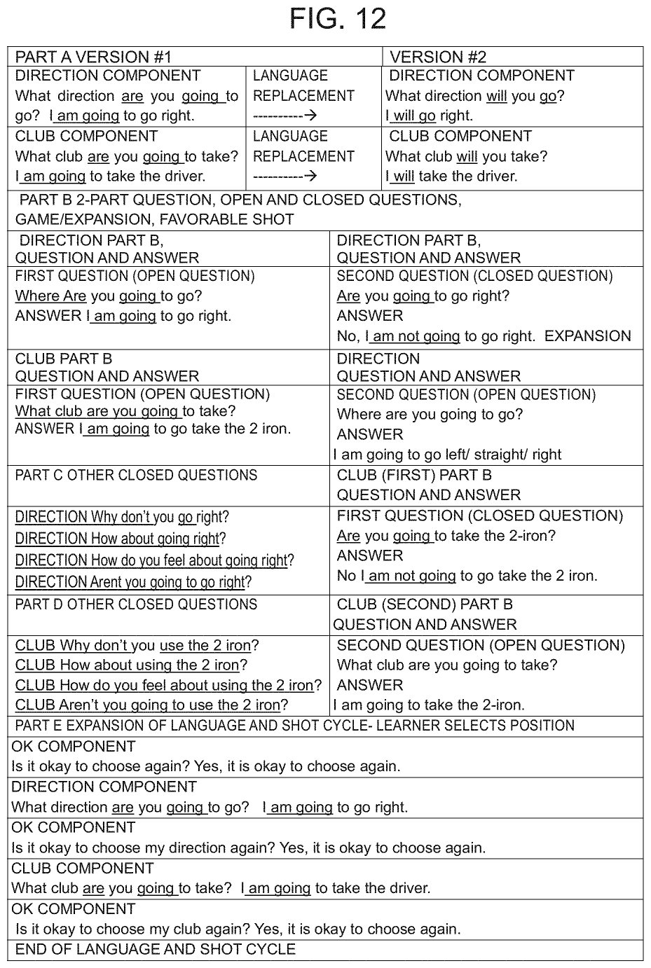

FIG. 12 illustrates a replacement probability of the question. The question or answer described on a right-side column (Version #2) is obtained by expanding and replacing the question or answer described on a left-side column (Version #1). For example, a question using “be going to” can be replaced by a question using “will”. Part A illustrates language replacement of a direction component and a club component. By means of the language replacement, “V+ING” is replaced by “V+WILL”. Part B illustrates the expansion of the component. The expansion includes two types of questions in the component. The two types of questions are a closed question (answered by yes or no) and an open question (plural answers). This expands the language and shot cycle. The language replacement can be used also for a 2-part question.

2-part questions may be used in the game. However, new logic, algorithms, and game design may be considered for making the two-part. For the execution of a 2-part question, the game may generate a yes/no answer scenario from the learner for the 2nd question to be required. The yes/no question is implemented more easily with the club component. In the case of the club component, it is probable that a “no “answer be generated from a question when the longest powered club is recommended and the distance is very short. An example of this is the longest club is 25-50 meters; the medium club is 10-25 meters; the short club is 1-10 meters; shooting distance is 7 meters. In this case the recommendation of the longest club would generate the “no” response and lead to the 2nd part of 2-part question. For example, would you like the longest club? No, I wouldn't. What club would you like? I would like the short club. This can be done in testing mode or play mode.

The language replacement can be further used for question in a 3-part constitution in the component. A question of proposal, that is, Part C illustrates a special question type in the direction component. A question of proposal, that is, Part D illustrates a special question type in the club component. In Part E, the language and the shot cycle become longer. For the direction or the club re-selected after returning, the language and the shot cycle are made longer.

Other questions or answers obtained by the replacement shown in FIG. 12 are stored in the storage portion 28 and give variations of the conversation. When the learner makes an answer, if the answer is within a range of replacement of one answer, the answer is recognized to be correct. For example, even if the learner answers with the word “will” to a question using “be going to”, it is recognized as a correct answer in the foreign language practice device.

Moreover, when the game is repeatedly played, the learner remembers the questions and the answer options in each card in some cases. In order to handle such a case, the foreign language practice device may be constituted such that in the direction content card and the club content card, options of original correct expressions can be replaced by options of wrong expressions or the options of wrong expressions are added. In this case, description contents of each card stored in the storage portion 28 are changed by the operation of the operation portion 10. Moreover, if each card is formed by actual paper, plastic or the like, the descriptions on the cards may be rewritten so that the options of original correct expressions can be replaced by options of wrong expressions or the options of wrong expressions are added.

Furthermore, the foreign language practice device may change a degree of difficulty of the questions illustrated by the direction content card and the club content card in accordance with the evaluation of the answer. For example, if the evaluation of the answer by the learner is good, the degree of difficulty of the question shown subsequently by the direction content card and the club content card may be made higher. On the other hand, if the evaluation of the answer by the learner is not good, the degree of difficulty of the question shown subsequently by the direction content card and the club content card may be made lower.

### Automated Difficulty Adjustment

According to one aspect, each question on respective question cards may be or have an associated degree of difficulty. For example, the degree of difficulty may be scored on a scale from one to ten. As discussed above, if the evaluation of the answer by the learner is good (e.g., above a threshold evaluation level), the degree of difficulty of the question shown subsequently by the direction content card and the club content card may be made higher. Conversely, if the evaluation of the answer by the learner is not good (e.g., below the threshold evaluation level), the degree of difficulty of the question shown subsequently by the direction content card and the club content card may be made lower, for example.

According to another aspect, the language learner may be assigned or associated with an evaluation level score (e.g., via the answer recognition portion 22 or the execution portion 24) which may be indicative of a skill associated with that language learner. Further, this evaluation level score may include one or more components, such as a score for vocabulary, a score for response time, a score for question response testing, a score for comprehension of present tense, a score for comprehension of past tense, a score for comprehension of future tense, a score for comprehension of simple present tense, a score for comprehension of simple past tense, etc.

For example, good fluentness (e.g., greater than a threshold fluentness) moves the learner up the database ability level (question timer and narration speed change), while bad fluentness (e.g., less than a threshold fluentness) moves the learner down the database ability levels (question timer and narration speed change). These may be achieved or implemented via the question providing portion 20, the answer recognition portion 22, and the execution portion 24. Similarly, good accuracy (e.g., greater than an accuracy threshold) moves the learner up the database ability levels (database difficulty and level support changes), while bad accuracy (e.g., less than an accuracy threshold) moves the learner down the database ability levels (database difficulty and level support changes).

Additionally, the evaluation level score may be broken down or divided into three levels. For example, there may be three linguistic knowledge levels: beginner, intermediate, and advanced. Each linguistic knowledge level may be associated with different linguistic goals, language and linguistic structure challenges and testing methods. In each level there may be 3 databases (db) to manage the level of difficulty and motivation of the language learner: easy, medium, and hard. Thus, the types of questions posed to the language learner may be different depending on or based on the evaluation level score and/or linguistic knowledge level.

According to one aspect, the movement up or down can be shocking to the student. As a result, database change or language from the higher level can be gradually phased out as the easier language may be phased in. This can also be done for learners when they move up. The language level difficulty can be gradually phased in via the execution portion 24.

### Beginner Level

The beginner level may be for a new language learner (who has little to no exposure to the foreign language) who needs very simple testing with small differences in answers. The language knowledge may be to get a 70% accuracy in the following language or linguistic constructs: would like, want, simple present (e.g., do), to be, adjectives, adverbs, etc. The questions may focus on spelling, punctuation, capital letters, and a vs the, singular vs plural and other simple linguistic challenges when testing, such as punctuation and capitals.

Beginner testing may be as follows:

Q: What club will you take?

I. I will take the red club.

II. I will take the redy club.

III. I will take the rad club.

### Learning Environment

Beginners may be provided with a different learning environment than other knowledge levels. The difference between knowledge levels may be linguistic knowledge but also the environment for performance may be different. This due to beginners needing more time and advanced students more time pressure to improve.

### Narration Speed

The questions may be read and/or narrated. When narration of the questions may be used, the questions may be sometimes written and as the level progresses the written questions may be not displayed (e.g., approximately 80% through the level) and the questions may be narrated. The speed of the narration may be noticeably slow and one would imagine the speed that would be used with a parent speaking to a younger child with noticeable pauses and slightly stretched out words and phrases. The speed of narration may be determined based on an age of the language learner and/or a number of languages the language learner knows.

Narration time of question: 2.15, 2.1, 2.05, 2.0, 1.95, 1.9, 1.85, 1.8, 1.75 seconds.

### Advanced Level

The advanced level may be for a learner who has a lot of exposure to a foreign language, such as a learner who has studied extensively or lived abroad for an extensive period of time and needs a challenge linguistically. The language knowledge may be to get a 70% accuracy in the following language or linguistic constructs: mixing future tense and past tense, phrasal verbs, passive voice, gerunds, causative verbs “have”; causative verbs “get to”, tag questions 3-types, irregular language; review and use every level in the system. The advanced level focuses on language but testing will use linguistics' tricks such as using interchangeable verb tenses, verb tense accuracy, and spelling mistakes.

Advanced testing may be as follows:

Q: What club will you take?

I. I will takes the red club.

II. I am going the red club.

III. I am taking the red club.

### Narration Speed

The questions may be sometimes read and sometimes narrated. When narration of the questions is used, the questions may be sometimes written and as the level progresses the written questions may not be displayed (approximately 20% through the level) and the questions may be narrated.

The speed of the narration may be at a native speed with no slowing down or pauses. The speed may be that of a “News Anchor” asking a question where “time is money”. Words and phrases may be sometimes blended together such “I got you” becomes “gotch ya” and sometimes the speed may be so fast one might think the question may be almost curt. Intermediate may be judged as 00:00.90 seconds per question. In this regard, the device may blend words together when narrating (e.g., what do you mean->whadaya mean?) based on the advanced level learner.

Narration time of question: 1.15, 1.1, 1.05, 1.0, 0.95, 0.9, 0.85, 0.8, 0.75 seconds.

### Intermediate Level

Between the advanced and beginner, may be an intermediate learner who has a fair amount of exposure to the language but still makes mistakes such as verb tenses and producing consistent linguistic results. The language knowledge may be to get a 70% accuracy in the following language or linguistic constructs: past tense), need, should, must, can, comparatives, superlatives, “as good as”, recommendations and suggestions. Thus, the goal of this level may be testing for consistent use of verb tenses and matching. In addition, spelling and other types of linguistic testing may be implemented when testing.

Intermediate testing may be as follows:

Q: What club did you take?

I. I took the red club.

II. I toke the red club.

III. I took the red clubs.

In each linguistic knowledge levels there may be 10 ability levels: 9 testing levels and 1 language play level without testing. Each ability level has unique combination of database difficulty, support level, answer timer, and announcer speed.

For ability level 1-3, the database may be easy, the question adjustment may be 2 multiple choices. Furthermore, the key grammar or language construction may be underlined for ease of understanding. The difference between these ability levels may be the answer timer and the announcer speed.

For ability levels 4-5, the database may be medium, the question adjustment may be 3 multiple-choices. Furthermore, the key grammar or language construction may be underlined for ease of understanding. The difference between these ability levels may be the answer timer and the announcer speed.

For ability levels 6-9, the database may be hard, the question adjustment may be 3 multiple choices. Furthermore, the key grammar or language construction may not be underlined as to challenge the learner. The difference between these ability levels may be the answer timer and the announcer speed.

### Narration Speed

The questions may be sometimes read and sometimes narrated. When narration of the questions is used, the questions may be sometimes written and as the level progresses the written questions may not be displayed (approximately 50% through the level) and the questions may be narrated.

The speed of the narration may be between the beginner and advanced levels. The speed may be a touch slower than a native speed with a slight pause between some words and phrases. The feeling of the question would that be similar to that of a person asking a question gingerly or with caution. Intermediate may be judged as 00:01.00 seconds per question.

Narration time of question: 1.65, 1.60, 1.55, 1.50, 1.45, 1.40, 1.35, 1.30, 1.25 seconds.

### Timer

BEGINNER TIMER to answer the question: 36, 35, 34, 33, 32, 31, 30, 29, 28 seconds.

INTERMEDIATE TIMER to answer the question: 27, 26, 25, 24, 23, 22, 21, 20, 19 seconds.

ADVANCED TIMER to answer the question: 18, 17, 16, 15, 14, 13, 12, 11, 10 seconds.

The 70% success level may be utilized as a gaming motivation and along with this apparatus. To pass a linguistic knowledge level, the language learner may be required to reach ability level 7 through 9 with a 70% in accuracy and 70% in fluentness for all of the tested grammar or language structure.

The learner may be able to move to another grammar focus or language structure if they may be tired of it, but the learner must come back to it and reach the requisite level before moving up a linguistic knowledge level.

Once the learner is placed in a level, the system will continue to use algorithms to monitor the learner's results and game play to make sure the motivation stays high e.g., at least a 70% success ratio in gaming and learning. If the motivation is not maintained the learner can do another diagnostic game to determine their level. Or, a more suitable level can be recommended by the device to maintain motivation.

However, some learners like to push through difficult language levels, so level adjustment algorithms should not be done by exclusively by the system but agreed up by the learner as to not affect the motivation of the learner. The same is true for the learner who is has language results and game play that is too easy and language learning that is not challenging. They too, may be revaluated and changing language goals may be done with their consent to maintain motivation.

The device, via the execution portion and storage portion 28, may also track an overall success ratio to questions or testing and adjust difficulty of testing based on a predetermined success ratio. For example, it may be desirable to test such that a language learner achieves a 70% success ratio. In this regard, the degree of difficulty of the question shown subsequently may be adjusted in a randomized fashion to regress to the predetermined desired success ratio (e.g., 70%, 75%, etc.). Further, the device may mitigate discouraging results for the language learner by tallying a mental fatigue score for the language learner based on the length of the session, the number of incorrect answers provided in succession, etc.

Each time a user provides a correct answer, the user's score may be increased via the answer recognition portion 22 and the execution portion 24, for example. Each time the user provides an incorrect answer, the user's score may be decreased via the answer recognition portion 22 and the execution portion 24, for example. The scores may be grouped into multiple levels based on predetermined thresholds, and the subsequent question may be provided according to a user's current level. Additionally, machine learning may be implemented using a recurrent neural network or a convolutional neural network to learn an accent-oriented voice recognition system. For example, a French person learning to speak English may have a different pronunciation for many words, and may have a ‘French accent’ regarding his or her English vocabulary. In this regard, the system or device may account for this inherent accent and not penalize the native French speaker for accents associated with a spoken phrase using the accent-oriented voice recognition system of the device.

According to one aspect, the device may not only track the current success ratio against the predetermined success ratio, but may determine weaknesses by category and assign questions from the content cards (e.g., the direction content card, the club content card, etc.) based on the determined weaknesses of the language learner (e.g., vocabulary, translation of words, reading comprehension, listening comprehension, response time, question response testing, comprehension of present tense, comprehension of past tense, comprehension of future tense, comprehension of simple present tense, comprehension of simple past tense, etc.). In another embodiment, the language learner plays a game based on their linguistic weaknesses of improve their learning.

The answer can be received as a multiple choice and physical input. The system collects these mistakes. If the learner reaches a level of consistent mistakes the learner may be demotivated. Since the system is configured for a 70% gaming rule, when the learner is below the 70% level the system can be adjusted by algorithms. The algorithms can trigger visual aids to be displayed, such as underlining key parts of grammar in the question and the answer to help the learner. The machine learn could be set up so the algorithms take away this visual aid based on the predetermined success ratio.

The algorithms can also make the multiple-choice answers easier. If the learner is consistently faster than the time parameter, the speed is then collected and used for machine learning and system improvements regarding time parameters and what is a motivating speed. After the system learns the learner's ability the system algorithms could adjust to push the learner to their maximum fluency.

### Fluency

Fluency is a goal of the system. It is judged by the time parameters. The answer produced may be within the time parameters or judged as not fluent for physical input or spoken answers. The parameters can be adjusted for weak language learners or strong language learners by algorithms.

The system should be set so that the learners improve their fluency. If the fluency is outside parameters then the answer may be judged as wrong. The mistake is then collected and used for machine learning and system improvements regarding time parameters and what is acceptable. After the system learns the learner' ability the system algorithms could adjust the learner level to push the learner to their maximum fluency without the learner missing the fluency parameter.

If the language learner's % hole average fluentness may be 70%-79% hole average, the language learner can move up one ability level in terms of fluentness if the learner's answer speed (fluentness) may be faster than the timer. The results of the timer will be matched with a level that correlates to the timer. In this case the learner may be BEGINNER LEVEL 4. The FLUETNESS goal may be 2.00 seconds. If the learner's fluentness may be 1.85 with a 70% average the learners will move up to Ability level 5. At this new level, timer may be set to the new fluentness goal may be 1.85, and, the announcer speed moves from 2.00 seconds to 1.95 seconds. This supports the concept of gradual learning.

If the language learner's % hole average fluentness may be 80%-89% hole average, the language learner can move up two ability level in terms of fluentness if the learner's answer speed (fluentness) may be faster than the timer. If the learner's fluentness may be 1.85 with an 80% average the learners will move up to Ability level 6. This supports the idea of gradual learning and keeping the learner's motivation. Announcer speed and timer will move up accordingly.

If the language learner's % hole average fluentness may be 90%-99% hole average, the language learner can move up three ability levels in terms of fluentness if the learner's answer speed (fluentness) may be faster than the timer. If the learner's fluentness may be 1.85 with an 80% average the learners will move up to Ability level 7. This supports the idea of gradual learning and keeping the learner's motivation with greater challenge. Announcer speed and timer will move up accordingly.

The opposite may be also true for POOR FLUETNESS results. If the language learner's % hole average fluentness may be 60%-69% hole average, the language learner will move down one ability level in terms of fluentness if the learner's answer speed (fluentness) may be faster than the timer. If the learner's fluentness may be 1.85 with an 80% average the learners will move down one level to Ability level 3. This supports the idea of gradual learning and keeping the learner's motivation by not making the system to difficult. Fluentness for 50-59% hole average will move down two levels the Ability down to level 2. Fluentness for 40-49% hole average will move down three levels the Ability down to level 1.

If the learner is consistently faster than the time parameter, the speed is then collected and used for machine learning and system improvements regarding time parameters and what is a motivating speed. After the system learns the learner' ability the system algorithms could adjust to push the learner to their maximum fluency.

The answer may have a preset pronunciation parameter. The pronunciation of the answers may be within the parameters or judged as incorrect. The parameters can be adjusted by algorithms for a wider forgiveness for language learners with a strong accent. The strong accent may be detected by the device body portion 18 and the microphone 14 of the device.

The system should be set so that the learners improve their pronunciation. If the pronunciation is outside parameters then the answer is judged as wrong. The mistake is then collected and used for machine learning and system improvements regarding accents and what is acceptable. After the system learns the accent, algorithms could prompt the learner to try one more time when their answer is outside of the acceptable parameters.

The system should be configured regarding accents to not make learners feel embarrassed about their language, culture, and heritage. The goal is to provide a learning environment that supports learning, practice, and motivation.

According to one aspect, the device may, keeping in mind the current success and the predetermined success ratio, additionally track a number of consecutive correct and/or number of consecutive incorrect answers given and adjust question difficulty based thereon. For example, if a language learner achieves five questions (e.g., an exemplary threshold for questions answered correctly consecutively or a consecutive correct answer threshold) in a row correctly, the device may increase the level of difficulty of the subsequent question to achieve the predetermined success ratio. As another example, if the language learner answers three questions (e.g., an exemplary threshold for questions answered incorrectly or a consecutive incorrect answer threshold) in a row incorrectly, the device may decrease the level of difficulty of the subsequent question to achieve the predetermined success ratio.

### Accuracy

Ability may be judged in terms of accuracy and fluency and movement can be done separately.

Accuracy for the hole may be the average percentage of correct answers during a hole (6 shots). If the language learner may be 70% or higher in terms of accuracy, the language learner can move up one level. The results of the timer will be matched with a level that correlates to the database difficulty and LEVEL SUPPORT

In this case the learner may be BEGINNER LEVEL 4, if the hole accuracy may be 70%-79% average the learners will move up one level to database difficulty for level 5. At this new level, the level support may be the same in terms of underline (still used), question support may be 3 multiple choice (3MC) and question support with text may be the same. This supports the concept of gradual learning.

In this case the learner may be BEGINNER LEVEL 4, if the hole accuracy may be 80%-89% average the learners will move up two levels to database difficulty for level 6. At this new level, the level support may be the same in terms of underline (still used), question support may be 3 multiple choice (3MC) and question support with text may be the same. This supports the concept of gradual learning.

In this case the learner may be BEGINNER LEVEL 4, if the hole accuracy may be 90%-99% average the learners will move up three level to database difficulty for level 3. At this new level, the level support may be the same in terms of underline (still used), question support may be 3 multiple choice (3MC) and question support with text changes (there may be not text for the narrated question). This supports the concept of motivating the learner to their highest level but in a gradual manner.

The opposite may be also true for POOR Accuracy results. If the language learner's % hole average accuracy may be 60%-69% hole average, the language learner will move down one ability level in terms of accuracy. If the learner's accuracy for the hole average may be 60%-69% the learner's level will move down one level to Ability level 3. This supports the idea of gradual learning and keeping the learner's motivation by not making the system to difficult. Accuracy for 50-59% hole average will move down two levels to level 2. Fluentness for 40-49% hole average will move down three levels to level 1.

In an embodiment, the learner may be able to choose or object to the AUTOMATED DIFFICULTY SCALE and choose their desired ability levels.

In an embodiment, the narration speed does not move with timer speed and the learner can choose the narration speed.

In one embodiment, the learner can get more reward coins for a faster answer in the level. As the learner goes to the next fluentness level, the learner can get more coins for reaching the new fluentness level.

If difficulty continues, AUTOMATED DIFFICULTY ADJUSTMENT will assess the results after 1-2 holes and make recommendations after the hole to make sure the learner may be happy with the accuracy level and fluency level.

Every answer physically input answer will be will be logged and aggregated. The language mistakes for the will be a red flag for finding learning problems. Using the aggregated data, the machine algorithms can interpret the answers and correlate it to existing data. After a period of time the language evaluation the program can be trained to understand linguistic problems and level matching of variables more satisfactorily and improve AUTOMATED DIFFICULTY ADJUSTMENT. This will result in the AUTOMATED DIFFICULTY ADJUSTMENT making better recommendations for levels of language levels and speeds. By ongoing system improvements, in the future, the system can expand the number of levels to tailor the language learning experience further for the language learner's needs.

The logging of language also serves another purpose in linguistic improvement. The data from the learner's mistakes will be logged and patterns of poor grammar and linguistic structures will be identified. The learner can be informed of the consistent problems and then written drills and supplementary practice can be assigned to improve the weaknesses.

An embodiment of the physical input would allow the learner to mix different narration speeds with different linguistic knowledge levels to create new levels. In another embodiment, the amount of question narration for each level could be changed from 0% to 100%.

Further, the device may implement algorithms which enhance language learner motivation, such as by indicating that the language learner (e.g., user, player, etc.) is in a state in the game where he or she may achieve an award (e.g., shoot a three-pointer in basketball, hit a birdie putt, bowl a strike in bowling, hit a bullseye target, etc.). For example, the device may enhance language learner motivation by indicating that the language learner is in a position to achieve a birdie in the golf game if the language learner answers the next two questions correctly. The device may record the user's success rate when the motivation stressor is indicated (e.g., indicating that the language learner is in a position to achieve a birdie in the golf game). The device may determine that the user performs better under pressure (e.g., answering the subsequent question correctly when it is indicated that the language learner is in a position to achieve the birdie in the golf game) or the device may determine that the user fails under pressure (e.g., answering the subsequent question incorrectly when it is indicated that the language learner is in a position to achieve the birdie in the golf game) and adjust the indications of the motivation stressor accordingly.

Matching game events with language may be possible when showing the number of shots on the screen. If the shot number is 3, before the shot is taken”, you can get a 3″ may be announced. After the shot is missed, “You could not get 3” can be announced. In both cases, the concepts of “can” and “could” can be inferred by the timing relative to the game.

Matching game events with language is done for the experience component. An algorithm with a database is required to make the experience component. When a player does something for the first time in the game as per the game data logs, the game can announce or display: this is the first time to get a par or you have gotten a par for the first time. This can be done for many events and eventually get to making questions and doing testing. Other examples of the experience component are as follows: have you ever gone into the water? Have you already gotten a hole-in-one? Is this the first time for you to go out of bounce?

After the real-life role-play applications are practiced, the system is monitored for motivation. The learner will rate their motivation level, rate the relevance of the application, rate the language, and game balance. From that data, improvements in the systems may be done. If the learner is not motivated and the language and game balance is low, the game algorithm may be adjusted to motivate the learner. Furthermore, update database, is important long-term as difficult language and mistakes may be put into the system for review games that focus on mistakes.

The device may implement algorithms within the gaming environment to motivate the learner to get “hooked” on learning much like all the games, and apps commonly use. The game and apps seen as an evil can now be seen as a solution to educational problems. Consequently, you have game that supports, enhances, and motivates the learner. According to one aspect, the device implement algorithms within the gaming environment to motivate the learner to get “hooked” by adding gaming elements to language learning, such as a timer, coins, health, and magic places on the course to get other things, etc. In that sense, an automated difficulty adjustment system with its algorithms for gaming elements such as coins, health bonuses, game tricks, or special tools could also be added and managed to keep the motivation of the language learning by creating an environment whereby the language learner attains 70% in the gaming aspect of the apparatus.

The gradually improving their language knowledge and skill at golf at the same times creates an attachment to the game as their skill base progresses. Furthermore, getting rewards, recognition for good language use, passing levels with set goals, figuring out the best way to use language to play a game, finding gameplay strategies that help get coins and buy health for a character and collect language and game cards to achieve higher status in the community leads to a motivated language student and propels the student to reach their linguistic goals.

In the voice input aspect of the apparatus, the identification of the correct answer may be required in the set time period. However, the answer must be spoken by the voice recognition software. Because voice recognition, it may not recognize a correct answer when a correct answer may be spoken. As a result, the apparatus has been set up to motivate the learner and improve (self-correct) the system at the same time. To keep the motivation of the learner and not becoming self-conscious about accents or language misinterpretations by voice recognition systems a challenge system button was set up. This may be much like a challenge flag in football when the coach may be not happy with a referee's decision.

Naturally, the lower the level, the higher the probability of poor pronunciation despite choosing or uttering the correct answer. As a result, the beginner language learner has can challenge 80% of their responses. This means that if the learner chooses the correct answer from a, b, c manually and then utters the correct answer, but the voice recognition makes a mistake, the learner will understand their pronunciation problem, however, they will not be wrong in terms of accuracy.

For the intermediate language learner (LINGUISTIC KNOWLEDGE INTERMEDIATE) the probability of poor pronunciation may be lower. They, too, will feel the same way if the voice recognition software misinterprets their answer. However, at a higher level, the learner needs a challenge that may be suitable for their level. At the intermediate level the learner can challenge 50% of their responses. That means in the remaining 50% of responses, the learner has to correctly pronounce 20% of remaining 50%.

For the advanced language learner (LINGUISTIC KNOWLEDGE ADVANCED) the probability of poor pronunciation may be even lower. They, too, will be will feel the same way if the voice recognition software misinterprets their answer. However, at a higher level, the learner needs a challenge that may be suitable for their level. At the advanced level the learner can challenge 20% of their responses. That means in the remaining 80% of responses, the learner has to correctly pronounce 50% of remaining 70%.

In an embodiment, the learner does not have to worry about any voice recognition problems, as a mere attempt, right or wrong, will recognition of a correct answer.

In another embodiment, the learner chooses the level percentage of challenges for the voice recognition errors.

The voice input presents a particular challenge for the measuring accuracy.

Despite the advancements in language recognition software, some accents and some environments may be not conducive to voice input. As a result, the learner may provide an accurate answer, however, the accent or environment noise such as train noise, air-conditioners, and background conversations can reduce the effectiveness of the judgement. As a result, the message about these learners will be displayed for the learner to get the best results from the apparatus.

To solve, the problem of environmental noise and accents, the answers for multiple choice will include numbers or letters in front of the choices to deal with the previously mentioned obstacles. By adding numbers or letters in front of the linguistic choices, the probability for the voice recognition to identify that the learner has made the right letter or number choice and linguistic choice increases dramatically. If the voice recognition aspect has many incorrect answers, the apparatus will remind the learner to reduce environmental noise or use headphones with a mic to increase the linguistic improvement of the learner.

Location data will also be used to reconfigure the voice recognition software to deal with the regional linguistic issues that may be specific regional issues such as “R” vs. “L”, “V” as “B” in Japan and the sucking in and popping sounds in south East Asia.

In addition, the challenge button may be very effective for improving voice recognition. First, the language learner may be trying to say one of the 3 answers. Thus, we know what the learner's spoken intention is, the learner disputes the output of the voice recognition software with challenge button, thus, the system may recognize the problem with the recognition. After this the data can be logged and used later to improve the system as follows.

Every answer spoken answer will be will be logged and aggregated. Using the aggregated phonetic data with accents, the machine algorithms can interpret the voice and correlate it to existing data. After a period of time the language evaluation the program can be trained to interpret more correctly the spoken language (words, phrases, sentences) of non-native speakers that may be affected by accents.

The language challenge button will be a red flag for the aggregated data to be focused especial on for misinterpretations of the voice recognition software as the learner believes the software has made a mistake with the recognition of the language.

Accuracy and fluency measurement, the scaling up and down may be done in the same manner for voice input as the physical input (touch screen) except there may be a challenge system.

The language challenge button also serves another purpose in linguistic improvement. The misinterpret data will be logged and patterns of poor pronunciation will be identified. The learner can be informed of the consistent pronunciation problems and then phonetic drills and supplementary practice can be assigned to improve the weaknesses in accents.

According to one aspect, the learner has an infinite number of challenges against the linguistic software.

In another embodiment, the learner may be given only a limited number of challenges per level. The lower the level, the more challenges (1 per hole) and fewer challenges in higher levels (1 per level).

According to another aspect, the device may ask the user what the user has planned for the upcoming weekend, and the device may frame questions around the upcoming activity based on the user response. For example, if the user responds that he or she is golfing during the upcoming weekend, the device may implement the golf game questions from the direction card and the club card, etc. If the user responds that he or she is going camping during the upcoming weekend, the device may implement camping game questions from using camping content cards, for example. In this regard, if the user is going grocery shopping, the device may ask, “what are you going to purchase?”, “what flavor will you choose”, “what color will you buy”, etc.

In this way, the learner can choose their real-life role-play goal. After the system/database produces the necessary language from the language and game cycle and vocabulary to practice. Instead of using endless repetition, this system puts the necessary language into a game for the requisite repetition. The language testing components are intuitive. They are based on understood, and intuitive universal concept such as power (club component)/control (direction component)/start/stop/manners/location component. The learners see these components and naturally deduce the meaning of the language goal of the components.

Other language systems are either repetition systems without motivating the learner like a game or mindless repetition to reach a real-life goal. These other systems are merely digitalizing language learning by means of wrote memory and not improving the learning process.

Using the game as short-term goal, that game gives the learner and immediate application of the game and the language becomes relevant immediately. Learning anything is hard in general and stressful as seen by high school dropout numbers claiming that learning is not relevant to the learner's life. In other words, learners hate wrote memory. The mindless practice of grammar and language is turned into a game. After playing the game, half of the language for real-life application is pre-learned and overcoming a less stressful learning experience. The learner has acquired the language in a gradual and no stressful means. Instead of competing with games, this system embraces gaming as a tool for learning.

Further, the device may make adjustments for passive learning. To reduce the possibility of language learning overload, the device may add new the language to the game in a passive way. When introducing any new language into the club component or the direction component it may be best to focus on these components and practice making questions and answer with just the question and one answer. The learner is just playing the game and seeing the corresponding to the club component and the direction component. This type of learning is called play mode. This will keep the language learner from trying to overthink the language and become used to the new language and how the language in the question matches the language in the answer.

According to one aspect, the play mode can be complimented by having narration option for the question and answers to aid in the pronunciation. In addition, a translation button for the play mode with a question and one answer may help some language learners relax and enjoying learning and playing again.

Passively adding language to the game (i.e. not having to answer questions correctly but listening to new language added to the game in a patterned way) is a natural way for people to learn.

An exhibit of natural learning is the mistake component. After a mistake is made in the game, such as going into the water, the mistake component is activated by an algorithm. The learner is taught by the mistake component, after the mistake by narration or screen comment or both: “you made a mistake”. This is intuitive learning. The learner may become familiar the bad play equals a mistake and the learner deduces that meaning of the mistake component. Additionally, passive learning may be implemented by asking the player or language learner, “Did you make a mistake?” to enable conversation to continue.

Thus, language may be passively introduced into the language and shot cycle. After the game starts, the program analyzes the long-term language applications. If the long-term language applications require new language then the database components are prepared for language to be added in a passive manner. In this gameplay, the language is not tested, however, when events happened or are triggered, the language is introduced in a passive means by narrating the event.

If the system determines that the real-life role-play language applications do not require new languages at this point then the system will focus only on grammar practice in the language and shot cycle.

It may be determined that the language and shot cycle requires language to be passively introduced. The game starts, after that the start component, club component, direction component, and shoot component are used to practice the target language at this point in the database. After the first shot, the game determines if the ball is in the hole. If it is in the hole, the hole is finished. If the ball is not in the hole, it may be determined if the game triggers language or not.

Introducing language passively may be done with an intuitive trigger or event. The CAN component (ability) is very intuitive when the 3 clubs with 3 different levels of power (short/medium/long) is compared to a distance to the hole. The computer can calculate with algorithms which club can reach the hole vs the distance. The computer may choose the “long” club when the other clubs cannot reach the hole. When the “long” club can reach the hole the game displays or narrates“, the long club can reach the hole”. As all clubs have different ranges, when the medium club distance range is measured against the shot distance, and the medium club is in range, the game displays or narrates“, the medium club can reach the hole.” The same is for the short club when it is in the range of the hole. These three examples are intuitive for the learner to understand the concept of “can” because of the context of the game. After the learner does enough repetitions of the hole, the passive learning through narration switches to active practice of the language. This system utilizes 9 holes for passive learning: 3 shots per hole×9 holes (27 repetitions) is enough repetitions for the learner to understand.

Components in the language and shot cycle are sometimes triggered by events. In this case, when the language is triggered by the event of “distance to the hole and clubs” for the “can” concept, this time, the CAN component/triggered language active use component is measured in terms of accuracy and fluency, and rewarded with coins or the shot may be affected (ball bounce).

In another embodiment, before the passive or the active the concept of “can” may be explained in the target language or the mother tongue depending on the configuration of the system by the learner.

After each hole is finished, the results of the active component “can” may be evaluated in terms of success. Once the learner reaches the 70% gaming accuracy the learner may be inferred to understand the concept. The system is set up for active use of the new language to be 9 holes (3 shots/per hole), 9 practices of the language. If the learner reaches 70% or higher ahead of 9 holes, the passive language could be introduced and the active component could be cut or removed. Furthered, the passive use of the language introduction and the active use might have to be changed. This may be done by analyzing the data and setting up and algorithm to balance the language to motivate the learner.

The contents in each language card for proceeding with the question and the conversation shown in FIGS. 9 to 12 are stored as a database in the storage portion 28.

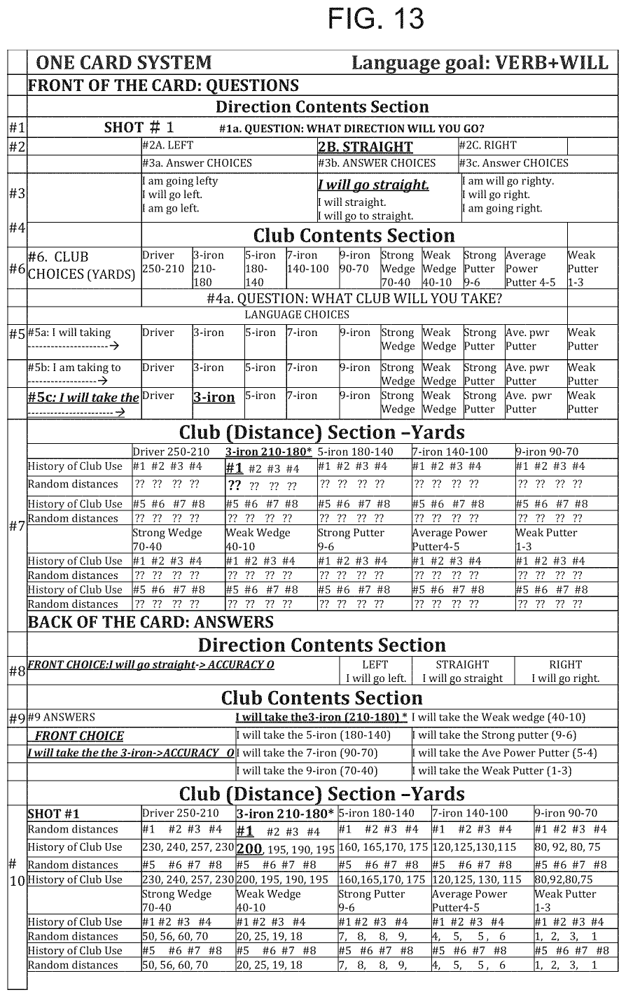

FIG. 13 illustrates an example of a complex card used in a one-card type game. The complex card may be formed by paper, plastic or the like or may be displayed on the display portion 16 of the foreign language practice device. The complex card integrates the aforementioned direction content card, the club content card, and the club distance card in one card.

The complex card includes a direction content section, a club content section, and a club (distance) section. Columns #1 to #7 are described on a front of the complex card, while columns #8 to #10 are described on a back of the complex card.

In the column #1, a question “What direction will you go?” is illustrated. In the column #2 in the direction content section, “2A. LEFT”, “2B. STRAIGHT”, “2C. RIGHT” are illustrated as options of the direction. In the column #3, answer options for each direction are illustrated. FIG. 13 illustrates that “2B. STRAIGHT” was selected and moreover, “I will go straight.” was selected.

On the column #4a in the club contents, a question “What club will you take?” is illustrated. Moreover, as three answer options when the club is to be selected, “#5a: I will taking . . . ”, “#5b: I am taking to . . . ”, and “#5c: I will take the . . . ” are illustrated. Furthermore, 10 types of club options are illustrated to each answer. FIG. 13 illustrates that “#5c: I will take the . . . ” was selected as an answer, and moreover, the No. 3 iron “3-iron” was selected as a club.

In the column #7, the club (distance) section is illustrated. In each of columns for the 10 types of clubs, symbols “#1” to “#8” are illustrated, and it is shown that the ball distance can be determined for each of the first to eighth shots. However, in the club (distance) section in the column #7, the symbols “??” are given as the carry in each column, and it is shown that the club (distance) section in the column #10 illustrated on the back surface should be referred to.

In the column #8, the correct answers for the questions in the direction content section are illustrated. That is, accurate answers for each of “LEFT”, “STRAIGHT” and “RIGHT” are illustrated. Moreover, “ACCURACY 0” is illustrated to the answer “I will go straight” made on the front surface, and it is shown that the answer was correct.

In the column #9, the correct answers for the questions in the club content section are illustrated. That is, correct answers for each of the 10 types of clubs are illustrated. Moreover, “ACCURACY 0” is illustrated to the answer “I will take the 3-iron” made on the front surface, and it is shown that the answer was correct.

In the column #10, the club (distance) section is illustrated. The symbols “#1” to “#8” are illustrated in each of the columns for the 10 types of clubs, and the carry for each of the first to eighth shots is shown, respectively. In this figure, it is shown that the carry at the first shot using the No. 3 iron is 200 yards. Moreover, for example, it is shown that the carry at the third shot using No. 7 iron is 130 yards, and the carry at the sixth shot using the strong wedge is 56 yards.

In the conversation process using the complex card, the club, the direction, and carry of the ball used at each shot are determined. Moreover, the evaluation is made for the answer to the learner.

Moreover, if the complex card is shown by the foreign language practice device, each carry described in the club (distance) section in the column #10 may be set in advance at random by the foreign language practice device. Moreover, in either cases where the complex card is formed by paper, plastic or the like or where it is shown by the foreign language practice device, each carry may be determined in advance at random by the teacher or the learner.

In the one-card type game, the ball distance of the ball is determined at random. Thus, the progress state of the game is diversified, the game becomes more attractive for the learner, and moreover, learning motivation of the learner is increased.

The complex cards may be divided into three kinds of cards. For example, it may be so configured that the direction content section is described on the front and back of a first card, the club content section is described on the front and back of a second card, and the club (distance) section is described on the front and back of a third card. Moreover, the complex cards may be divided into two kinds of cards. For example, it may be so configured that the direction content section and the club content section are described on the front and back of the first card, and the club (distance) section is described on the front and back of the second card.

According to the foreign language practice device according to this embodiment, an opportunity of intuitive communication without a translation in mind can be provided to a learner. Moreover, an opportunity of active or passive communication according to a situation can be provided to a learner. Furthermore, while an inappropriate expression is pointed out and an opportunity of repetitious practice and the like is provided to the learner, an opportunity of enjoyable and efficient foreign language practice can be given to the learner. Moreover, foreign language learning can be further simplified. As a result, the learner can maintain motivation to the foreign language learning and can learn competency of natural and quick communication.

In the above, the embodiment of practicing conversation has been described. The foreign language practice device according to this embodiment may be used also for practice of reading/writing. In this case, the question by the language card is displayed on the display portion 16, and the learner answers by inputting characters from the operation portion 10. The practice of conversation or reading/writing may relate to other subjects such as mathematics, physics, and the like. Moreover, the present invention may be used as a measure for a standardized test examining linguistic competence such as TOEIC (registered trademark).

Moreover, the present invention can be used for learning of a foreign language other than English. Furthermore, a child who has not sufficiently learned the native language may use it for learning of the native language.

Moreover, each language card, the game field 36, the evaluation sheet 40 and the like displayed on the display portion 16 may be a real language teaching material printed on a sheet-like printed medium such as paper, plastic and the like. In this case, a role of the foreign language practice device is played by a teacher who is a human being. The question displayed on the language card does not have to be a complete sentence but may be information for the teacher to identify the question determined in advance. That is, the question displayed on the language card may be an abridged sentence, a symbol, a sign, a figure, a color, and the like that the teacher can recognize what question should be asked. Moreover, by allowing the learner and the teacher to remember a part of the conversation in advance, the sentence described on the language card may be omitted as appropriate. In this case, it may be so configured that required minimum abridged sentence, symbol, sign, figure, color and the like are described on the language card so that the learner and the teacher proceed with the conversation.

### Embodiment 1

In the following, the embodiment of the present invention may be described in detail. The foreign language practice device according to the embodiment of the present invention is a language device which can be incorporated in many games for teaching, learning, reviewing, using, testing, remunerating for, and enjoying facts and concepts of a language. This device can be used by a student learning a foreign language or a child learning the native language.

### 1. Current Situation of Art

For a long time of teaching English to people whose native language is not English (more than 30,000 classes), the inventor has observed that the students found difficulty in learning language or grammatical principles and facts. That is because proficiency requires a lot of tiresome language repetition. In order to overcome the language repetition, this device incorporates the language repetition in a game. As attentions of many scholars and documents are drawn, to learn by playing a game is an excellent and effective method.

### 2. Prior Art

Through patent searches by the inventor, there was no direct matching or similar concepts. In order to protect the invention in the present application, the inventor illustrates how excellent this device is as compared with the other systems in which language learning is incorporated in a game in terms of methodology of the prior art and an aspect of a game.

### (1) Language Learning Incorporated in Game—Methodology of Prior Art

Concerning the language learning and a game, the following indicates that the inventor's language learning methodology is more excellent than the other language learning systems.

U.S. Pat. No. 5,458,338 has a learning structure, a card, and a marker but that is inferior to the invention of the present application in application of a new language in a conversation or a real life and is lacking in a game aspect of giving motivation. U.S. Pat. No. 6,076,828 uses a card and develops a language skill, but students return to language translation and fluentness is sacrificed. U.S. Pat. No. 5,458,338 does not have an aspect of structured conversation. The lack of structure makes understanding of a new language non-intuitive and acquisition of the new language ineffective. Games such as U.S. Pat. Nos. 7,604,236 and 4,890,844 give only passive knowledge of words to students. U.S. Pat. No. 7,604,236 only identifies and matches a word or a phrase with a card and a board game, and students are not allowed to actively use the new language.

### (2) Language Learning Incorporated in Game—Game Aspect of Prior Art

Concerning the language learning and games, the following tests and indicates how excellent the game aspect of the invention in the present application is as compared with the other systems.

U.S. Pat. No. 7,604,236 is a card game and its play is predictable and is different from the device according to the invention in the present application in which the language controls the ball by accuracy and fluentness and the result influences the game play. In U.S. Pat. No. 6,341,958, the learner can automatically switch off necessity of translation and explanation as in the device of the inventor, but there is no game play. Square Enix in U.S. Pat. No. 7,591,721 is a patent of a video game and is not a language. Square Enix uses “a video game which applies a predetermined rule to a game progress and imposes a penalty in case of a rule violation”. This language system imposes a penalty on a bad game play as in Square Enix but this language system also applies a penalty on use of a bad language. Similarly, a language result influences a shot and also influences control of the shot. In terms of the video game, it seems that a video game console or a controller short-circuits or works better for the language result. This unique and seamless incorporation makes separation between the language learning and the game impossible and its uniqueness also increases motivation for learning. U.S. Pat. No. 4,171,816 identifies a type of the grammar, language concepts, and utterance parts but unlike this device, they are not used actively for utterance or progress of the game. Other trials in Englishtown and Rosetta Stone lack in consistent structure such as a language and shot cycle. Moreover, the system is not constructed on the game and thus, the learner's motivation given for continuation of the learning is lowered. U.S. Pat. No. 4,890,844 uses a card in a game and only tests accuracy of the language in a memory game, and motivation given to the learner is far lower than playing golf. An art described in pending U.S. Application Publication No. US2007/0015121A1 uses a character and requires achievement of a goal through communication between the language and the virtual characters. On the contrary, this language device has a player profile having a given profile such as an age, power, clothes, money, and energy. As the game progresses, these characters change and influence the game play directly or indirectly.

### 3. What to Overcome

For a long time during which the inventor has been a teacher of a language conversation, the inventor observed that language learners had difficulties as follows in foreign language learning.

When a learner uses a foreign language, a system which is not to translate to the native language or from the native language is needed. Such a system that enables repetition of the language is needed. Such a system that the student does not translate in mind is needed by prompting the learner to answer quickly. Such a system that requires passive and active use of the language is needed. Such a system of intuitive language learning is needed. Such a system that increases vocabulary of the learner by language replacement is needed. Such a system that gives that immediate feedback to the learner is required is needed. Such a system that reviews the language learned before and further progresses it is needed. Such a system that takes in the above and makes learning enjoyable is needed.

### 4. Major Object

A goal of the device is to stimulate the language learning through a game such as golf, other sports games, or a role-playing game. The language is used in a language and shot cycle made of a speaking component. Each component uses the new language in a question and an answer and is measured in terms of accuracy and fluentness. The component is used for controlling the game, and the language result of the component influences the game or control of the game and thus, increases motivation of the language learner. Furthermore, a label in the device makes the learning intuitive and makes the learning enjoyable.

### 5. Advantageous Effect

Since the device is intuitive, the device shows how the language influences the game, its score, and the life and thus, students are further given motivation to learn the language. Since the language result influences the game play, fluentness and accuracy are improved. Since the structure requires proficiency in both passive and active knowledge of the student, they are increased. The students can use the new language in questions and answers. The structure and the label increase the knowledge and use of the language as follows. That is, what words should be used, how they should be used, when they should be used, why we use them, and where they should be used. The immediate language feedback and the repeated game play make the students speak with more confidence. The learner can understand the language pattern from the labeling, which enables replaced language of the language. Since there is pressure and realization of the fluentness, language translation with the native language is decreased. The teacher gives motivation and owns a new tool for teaching a language.

### 6. Major Steps to be Used

A golf grid (e.g., a lattice) may be created by boxes overlapped on the golf course so that the student can mark the shot. In order to mark the shot and to count the score after playing the hole is finished, a circular marker is used. A shot arrow is used for selecting a direction on the golf surface. The content card (language card) is used, the ball is moved, and movement of the student from start to end of playing the hole is supported. In order to measure achievement of the goal of fluentness by the student, a timer is used.

The language to be learned is selected from the content card. The content card is made so that the student can understand how the question and the answer are made by the new language in the language and shot cycle. A language result record chart indicates that the language result (in terms of accuracy and fluentness) influences the shot.

### 7. Practice Using Foreign Language Practice Device

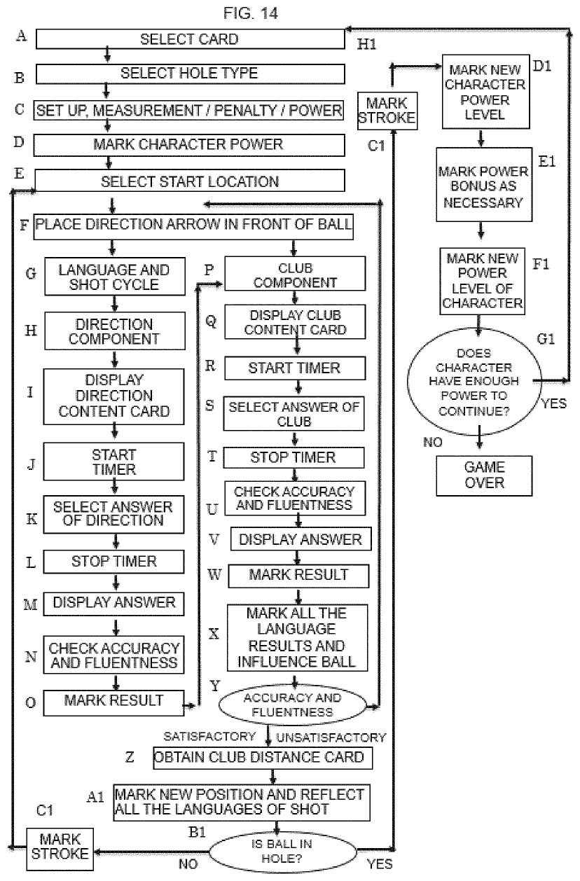

The core of this device is the language and shot cycle as illustrated in FIG. 14. The language and shot cycle incorporates the language practice in golf. The language and shot cycle has a language goal (defined by the label) and is made of components composed in a pattern for carrying out a conversation relating to golf. Since the label defines the component, it is easy to introduce the language and to replace it. In each component, the language is used for forming a question and an answer, and the result is measured in terms of accuracy and fluentness, and the results influence the shot. Lastly, the number of components can be expanded or reduced (e.g., vocabulary component; direction component; club component; shot component).

To ask about the game (e.g., a how component), score of the game (e.g., score component), (time component) are added at the end of the language and shot cycle to make logical sense about the game. By changing the order other how component/score component/time component) can be added. For example, language used in the how component are as follows: how was your game? How did you do in the game? How did the game go? For example, language used in the time are as follows: how long did you play for? How long did it take to play the hole? For example, language used in the score component are as follows: what was your score? How many shots did you take? With the time component: time logs from the start of the game to the current time can be used to make questions for the progressive forms. Questions as follows can be asked: how long have you played? Since when have you played?

The vocabulary component allows the vocabulary and phrases to be tested in the game. The language that might be added are phrases from future short or long real-life scenarios. This allows the learner to pre-learn the language. This will help the learner prepare for this final linguistic goal in a gradual way.

In other embodiments, the vocabulary component, the language learner has a learning goal of acquiring specific vocabulary and brushing up on grammar. The language and shot cycle will help the language learner reach the grammatical goal and the vocabulary card can be used to tailor the vocabulary component by being able to focuses and choosing from a multitude of vocabulary cards from science, history, business, travel, politics, finance, marketing so the learner can reach their goals.

This is one case that allows the learner to tailor their language goals perfectly to their needs. The language cards could have an explanation in the mother tongue or an explanation in the target language. The benefit of using a digital form of learning with many vocabulary databases allows the learner to focus on many topics in detail without looking around for databases or searching the internet for different database flash cards. This flexibility motivates language learners.

### (1) Analog Language and Shot Cycle—Golf Flowchart (FIG. 14)

FIG. 14 illustrates how the language controls (proceeds with) the game. The game is influenced by the language. And it illustrates how an environment gives motivation relating to good use of a language. The learner uses this device from the start of the game (a shot place of the first shot) and advances the ball until the game ends (the ball is in the hole).

A. “Select card”—The content card is a unique method of expressing a component and each content card has a large number of content cards. The type and the number of the content cards are selected based on language needs of the learner.

B. “Select hole type”—The selected hole type is based on the language needs of the learner. Each hole has various variables influencing the vocabulary and the grammar.

C. “Setup”—The measurement determines how the language is measured (accuracy and fluentness) and penalties. The language penalty determines how the language result influences the ball. A power amount determines a play environment (start power, power usage, and play remuneration). Adjustment of these variables influences the learning environment.

D. “Mark character power”—The learner marks its start power level and a money level.

E. “Select start location”—The learner selects a start location on the course, marks it, and moves the marker to the start location.

F. “Place direction arrow in front of ball”—A direction arrow is placed in front of the ball indicating three direction options: left, straight, right from each ball position.

G. “Language and shot cycle” is made of direction and club components. This indicates a goal of the subsequent speaking sequence and also indicates a repetitious speaking pattern.

H. “Direction component”—The question and answer relating to the direction determine the direction of the ball. The language is provided by the content card.

I. “Display direction content card”—The direction content card is displayed near the learner. The learner sees the question and answer.

J. “Start timer”—The timer is started. Measurement of fluentness is started.

K. “Select answer of direction”—The learner selects an answer.

L. “Stop timer”—The timer is stopped, and the time is recorded.

M. “Display answer”—The direction content card is turned over, and the answer is displayed.

N. “Check accuracy and fluentness”—Concerning the accuracy, the answer is checked with respect to the back surface of the language card. Concerning the fluentness, the recorded time is checked with respect to the goal of the fluentness, and the result is recorded on the evaluation sheet.

O. “Mark the result”—The result of the direction component is recorded. Concerning the accuracy and the fluentness, O means that the answer was satisfactory, while X indicates that the answer is not satisfactory (FIG. 8).

P. “Club component”—The question and answer relating to the club using the content card determines the distance of the ball.

Q. “Display club content card”—The direction content card is displayed near the learner. The learner sees the question and answer.

R. “Start timer”—The timer is started. The measurement of the fluentness is started.

S. “Select answer of club”—The learner selects the answer and the club.

T. “Stop timer”—The timer is stopped, and the time is recorded.

U. “Check accuracy and fluentness”—Concerning the accuracy, the answer is checked with respect to the back surface of the language card. Concerning the fluentness, the recorded time is checked with respect to the goal of the fluentness, and the result is recorded on the evaluation sheet exemplified in FIG. 8.

V. “Display answer”—The club content card is turned over, and the answer is displayed.

W. “Mark the result”—The result of the direction component is recorded.

X. “Mark all the language results and influence ball”—The results of the direction and club components are added. They both influence the shot.

Y. “Is accuracy/fluentness satisfactory?”—The language result is measured with respect to the goal set in “setup”. If the language goal is not achieved, the learner carries out the language cycle again.

Z. “Take club distance card”—After the language goal is achieved, the club distance card (the same club as the club language component) is taken and turned upside down concerning the shot distance.

A1. Mark the new position and influence of all the languages with respect to the shot. The ball is moved to the new position, the language result (penalty) is applied to the shot, and the ball is moved in accordance with the rule determined in advance as shown in FIG. 8.

B1. “Is ball in hole?”—If the ball is not in the hole, the learner returns to F and repeats the language and shot cycle until he/she finishes the cycle. If the ball is in the hole, the language and shot cycle is finished, and the hole is also finished.

C1. “Mark stroke on card of learner”—The number of strokes to finish the hole is recorded.

D1. “Mark new character power level”—Indicates the power amount used at the hole. Power use rule: 3 holes=1 bar, 9 holes=3 bars, 1 hole=1 sub-bar.

E1. “Mark power bonus”—If the player is given a good score in compliance with the golf rule, the learner gains a power bonus. Eagle=4 power bars, birdie=3 power bars, Par=2 power bars, bogey=1 power bar.

F1. “Mark new power level of character”—The power level is changed after the bonus power bonus is added.

G1. “Does character have power enough for continuation?”—If the learner does not have sufficient power, the game is finished.

H1. “Select content card” indicates start of a new hole. This point is the same as the A point.

### (2) Language Option for Speaking Structure and Ball Control (FIGS. 4A to 4C)

The content card enables control of language practice and shot by the direction component (direction control) and the club component (distance control). There are many various types of content cards by various methods expressing the components in terms of words, grammar, idioms, and phrases. The content card is a unique method of expressing the component, and each content card has a large number of content cards concerning the component. The large number of content cards tests a unique method expressing the component by using various multiple-choice cards. On the front surface of the content card, clear language is used for a question and three possible answers. The correct answer is on the back surface. In this embodiment, the language and shot cycle has two components, that is, the direction component and the club component. The direction component has a bundle of direction content cards. The club component has a bundle of club content cards and a bundle of the club distance cards.

The goal is to move the ball from the start to the end by using the smallest number of shots by using a club card option list for reference. In order to minimize the number of sets (decks) and play fields, the following 11 sets of club distance cards can be used: Three putter sets (weak power, average power, strong power), three wedge sets (weak power, average power, strong power), one No. 9 iron set, one No. 7 iron set, one No. 5 iron set, one No. 3 iron set, and one driver set.

### (3) How to Use

First, on the direction content card, the language learner selects a direction option from (left, straight, right), selects a language answer from language multiple-choice answers, and checks the answer on the back surface of the (left, straight, right) options.

Subsequently, the learner selects one club from 11 club options on the club content card, selects one language answer from three multiple-choice answers, and checks the answer on the back surface.

Lastly, the learner selects the club distance card corresponding to the club selected on the club content card, turns it upside down so as to indicate the distance, and moves the ball in accordance with the card. The distance on the club distance card follows a standard deviation within a range of the card and other statistical rules. By using the statistical rules, the game is made more reliable, and the learner can enjoy the game play.

According to one aspect, the complex card may function as a randomizing power generator. The distance card may also function as a randomizing power generator. Because the players do not see the back of the cards immediately, the complex card, the distance card, or other cards may function as a randomizing program when accessed by a computer. Thus, the complex cards can be understood as a program to randomize shot distance or power.

In order to minimize the number of card sets, the set of the club distance cards can be used by any type of club content card set. Concerning a specific language on the content card, at least four different versions of content cards, that is, four multiple-choice answer sets may be utilized.

In another embodiment, the distance card set may be a complete golf club set, and concerning each club, there can be one or more power distances.

In another embodiment, the distance card may have one power distance as 150 yards, and the learner has an option of using a distance and an option of using a percentage distance card for control. For example, it is assumed that 150 yards (30%)=45 yards. 150 yards (60%)=90 yards.

The power of a shot may be determined by a conversation as follows. “What club are you using?”, “I am using a 3-iron (180 to 200 yards)”. “How much power are you using?”, “I am using 80% (144 to 160 yards).

In another embodiment, the description contents of each of the club content card and the club distance card can be described on the same card.

In another embodiment, the computer can collect information of the club content card and the card distance card, and the database stores all the answers and checks the answers to the database immediately. Stated another way, the language cards may be organized in patterns and in an efficient way in a database. In this way, databases are organized by patterns and in an efficient way. Because the language cards function is the same as the database, the language cards may be stored in the same format within the database, thereby enabling the computer to function more efficiently.

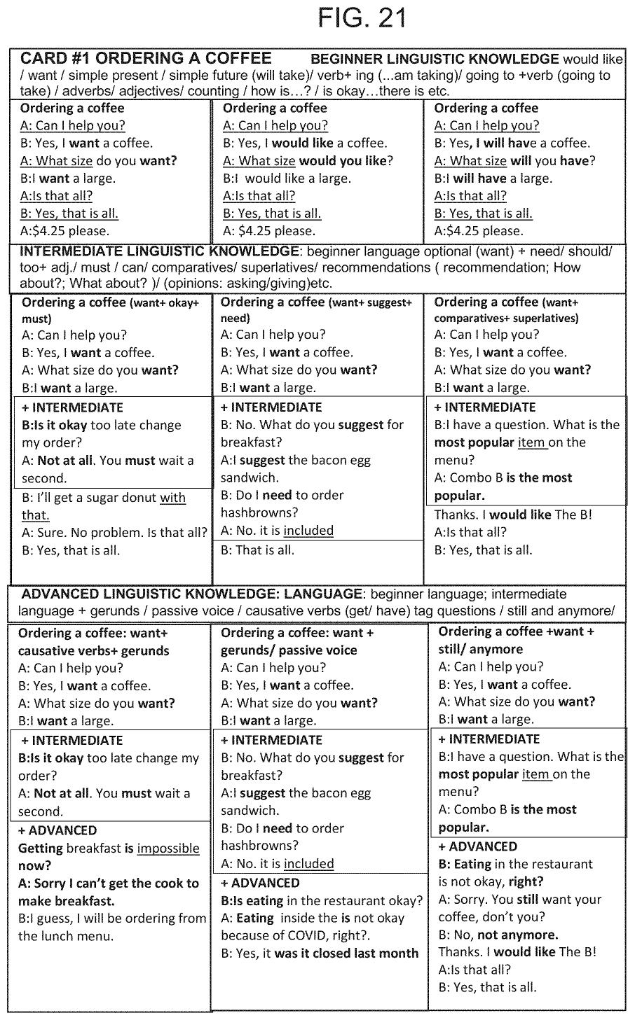

Again, the computer may be used as a medium to combine gaming and language learning. This system is efficient and improves the functioning of a computer because subjective language is changed into an objective form by implementing the components and/or card, such as direction, club, shoot, and others. This enables the language and/or cards to be made into a pattern which may be implemented directly into the database format, thereby improving access times and runtime execution efficiency. Examples of card construction may be seen in FIGS. 21-23.

According to one aspect, the database of questions and answers are called up to be shown on the screen at different times for different verb tenses. This is especially clear for simple present verb tenses ( . . . would like) vs simple past verb tenses. The past tense “match database options” may be called up after the “select option” an action for the past tense to make sense. Without doing this concept of past tense is not past and the language concept is unnatural and grammatically incorrect. Other considerations for the timing of the database is for “question testing”. In the question testing, the timing of the database is and selection is different from simple present and has to be considered along with other language goals such as recommendations and their components.

For example, the question presented may be “What club would you like?” and/or “What direction would you like?”. After club selection by the language learner, a confirmation or follow-up question may be presented, such as “What club did you choose?” and/or “What direction did you select?”. Therefore, additional questions may be presented based directly on the answer provided by the language learner. Stated another way, confirmation questions may be provided immediately following a selection in a question testing format.

According to one aspect, a ball bounce may be implemented that moves between the maximum and minimum distances of the cards. The ball bounce may be used as an incentive for language learning. If the player makes a mistake, the ball bounce may move faster. If the ball bounce moves faster, it becomes more difficult to make the shot. Additionally, passive learning may be added by making a comment about the mistake: “you made a mistake.” In addition, active learning may be implemented, such as by asking the player or language learner, “did you make a mistake?”

The ball bounce was added to further stimulate language learning. If the learner does not proficiently use the language (meet the timer/not fluent or incorrect answer) the learner's game play is affect by the ball bounce. Each club has a ball bounce with unique characteristics: the longest club has the fastest ball bounce; the shortest club has the slowest ball bounce; the middle club has the medium speed ball bounce. The ball bounces are motivating as it is the means of controlling the power within the range of the selected club.

The ball bounce moves between the minimum and maximum number of the ball bounce. When the player wants to make a shot and reads on the screen that the distance is 20 meters and the medium club is 10-25 meters. The player will want to touch the ball bounce when the ball is passing the 20-meter marker in the ball bounce. However, if the learner is does not meet the timer/is not fluent/or has an incorrect answer, the ball bounce speeds up in the game and makes the shot more difficult. Thus, the language learner is motivated to meet all language goals.

Furthermore, if the language learner misses the shot because of a fast ball bounce, the language learner will lose out on achievement coins for the hole. To make this more motivating, the language learner will play in a community, classroom, or on-line group. By making mistakes, the score may be affected along with the language score, thus the ball bounce is a motivating aspect of the apparatus.

Achievement also drives the game forward by the level pass points in the game. This system has 3 requirements that the language learner may achieve: 70% level for language use, 70% par rate; and a requisite coin level depending on the language level and whole design. In this case, language learning and game play are inseparable hence, gaming supports language learning.

In another embodiment, another type of card having a distance such as between two points or in a role-playing game can be used for moving the ball from the start to the end. In one case, the golf club can be replaced by food. For example, meat having a high power is for a long shot, and lettuce having a low power is for a short shot. In another case, the power shots may be determined from healthy food, and the weak power shot may be determined from junk food.

### (4) Assumed Practice Method

In one embodiment of a use method, the learner just observes the question and answer of the language and shot cycle, but the learner can yet play the game.

In one embodiment, the learner tests the knowledge by selecting one correct answer from many options and can play the game.

In one embodiment, the learner tests the knowledge by selecting two or more correct answers from many options and can play the game.

In another embodiment, the learner can read out the card and plays the game, not a test of the language.

In another embodiment, the phonetic pronunciation of the questions and answers are written on the cards and the game gives the learner reading practice that supplements a reading program.

In another embodiment, the learner can ask a question without seeing the card and practices the language and can play the game until he/she can answer. However, they can use the card to check the answer. They can do this by preparing blank language cards of the direction content card, the club content card, and the club distance card or they can do this by using the club distance card after the questions and answers relating to the direction and club components are practiced orally.

In one embodiment, the teacher performs the use of the content card. Later, the learner reproduces the performance, uses the content card in the language and shot cycle and also plays golf.

In one embodiment, the teacher performs the use method of the language in words and plays the game by the club distance card. Later, the learner reproduces the performance and uses the club distance card in the language and shot cycle and plays golf. The teacher supports the language as necessary.

In one embodiment, the program by the content card in the database performs the use method of the content card. Later, the learner reproduces the content card in the language and shot cycle and plays golf.

In another embodiment, the language learner selects a plurality of content cards relating to each component of the language and shot cycle. The learner can mix various languages relating to the component while expecting the induction of an error of another learner. In this case, the learner performs review as a game tool.

In another embodiment, the language learner fills in the blank in the new language in the content card, checks the answer on the back surface, and also plays the game.

### (5) Language Test

Many possible methods which test excellence of the knowledge of the language of the learner are shown. In an embodiment of another use method using a computer, the learner can play a game and use the language in the question and answer by voice, a touch screen, typing or a mouse click or by using replacement of the question and answer in the network all over the world.

In another embodiment, means for testing may be finding of multiple choice, correct spelling, or correct usage of phrases or removal of wrong phrases.

In another embodiment, other variables capable of measuring language pronunciation and appropriateness can also influence a shot.

In another embodiment, instead of use of a language in a component, a variable such as correctness of spelling, accuracy of honorific expressions or accuracy of use of the language may be a goal and can influence the shot.

In another embodiment, the language learner reads the question aloud, reads the answer aloud, fills in the blank in the new language in the content card, reads the answer on the back surface aloud, checks the answer, and plays the game.

In another embodiment, the answer to the language card can be written on a blackboard or a whiteboard on the back of the player and be checked after selection of the answer.

In another embodiment, the learner reads the answer into the computer, it is temporary stored for play back, the learner plays back the answer and judges if the answer is proficient or not.

### (6) Language and Shot Cycle (FIG. 7)—Important Tool in Incorporating Language Learning in Golf Play for Intuitive Learning and Repetitious Learning

The language and shot cycle is made of patterned language components. Each component has a defined label and a language goal. That is, the components are composed by patterns and promote conversation relating to golf. The component is used, the ball is hit and controlled, and conversation is made with respect to golf. Each component uses the language in the question and answer and tests the language from the language card. The results of the question and answer influence the accuracy and fluentness influencing the shots.

FIG. 7 illustrates two versions of the language and shot cycle. This is a cycle based on the direction component and the club component. An upper stage (short version) in FIG. 7 and a lower stage (long version) in FIG. 7 illustrate cycles of moving the ball from the start to the end by using the language.

The goal of the direction component is to talk about selection of a direction and to move the ball. The goal of the club component is to talk about selection of an appropriate club and to move the ball. To define the language goal of the component in advance enables the “direction”, “club”, and “distance” to visually lead to the game play and makes the learning intuitive. These language options navigate the game and play a role of a joystick or a game controller. A real, physical joystick may be used for controlling the game. In this case, too, it may be so configured that an operation of the physical joystick is influenced by the evaluation to the learner.

In another embodiment, another language may be used as follows to control the game. How far are you hitting it?/I am hitting it a short distance/average distance/long distance. How much power are you going to use? I am going to use a little power, I am going to use an average amount of power, I am going to use a lot of power.

Since the system uses the game, and the game requires repetition in order to finish, the learner is given motivation to practice and to repeat. This is different from the other language learning system supporting a problem of translation between the native language and a new language of the learner.

In another embodiment, the component label can make learning further intuitive by using an intuitive symbol.

In another embodiment, the component label may be in the native language and may be changed to a foreign language after the learner gets used to the foreign language.

The lower stage in FIG. 7 is an embodiment different from the upper stage in FIG. 7. That expands the upper stage in FIG. 7 by expanding a possibility of another language relating to the language and shot cycle. An additional component of the language and shot cycle is as follows. A goal of the position component is to start the game by talking about selection of the position. A goal of a start component is to talk about starting of the game. A goal of a distance component is to talk about the distance of the ball as the result of selection of the club. A goal of a location component is to talk about where the location of the ball on the course is. A goal of a state component is to talk about what the shot should be. A goal of a continuation component is to talk about continuation or stop of the game.

The other components such as “position”, “start”, “continuation”, and “state” are similarly intuitive due to their natural order in the game play. The “position” component is located at the beginning, and many start options intuitively mean that the component goal is to select the position. The “start” component is located after the “position” and before the game play and thus, naturally gives the meaning of its “start” to the component. Similarly, English is used in international sports or games all over the world and the “start” is used at the beginning and therefore, the meaning is intuitive. The word “continue” is intuitive when the shot is finished and the play is not continued. To answer “Yes” or “No” to “continue”, the game is started or stopped and therefore, gives the meaning of the component. In another embodiment, “finished” is more intuitive than “continue” as the component label.

After a good or bad shot, the language learner or a gamer wants to talk about or express a feeling of the shot. Therefore, a “state” or a “feeling” component is intuitive in the game play after the shot. Moreover, to add a new component to the language and shot cycle should be done gradually so that the learner is not frustrated by too many languages.

According to one aspect, the device may implement gradual learning because learning is best when it is gradual and the learner is not saturated with learning. This allows learning to be gradually over a longer period of time. This allows the learner to get sufficient practice with the target language, build confidence, and stop translating from the mother language to the target language. The expansion of the language goal can be done extensively with language goals. For example, the device may expand the phrase “I prefer the red club” to “I prefer to choose the red club” over time based on a skill score associated with the language learner or user. For example, the skill score may be calculated by determined a score for different aspects of language learning for each language learner and adding the respective scores together (e.g., a score for vocabulary, a score for response time, a score for question response testing, a score for comprehension of present tense, a score for comprehension of past tense, a score for comprehension of future tense, a score for comprehension of simple present tense, a score for comprehension of simple past tense, etc.). This expansion of language phrases may be indicative of one aspect of increased difficulty for questions (e.g., associated degree of difficulty), for example. Stated another way, the larger the expansion or number of words in the phrase of the question, the higher the degree of difficulty of the question. In this way, expansion gives the language learner exposure other “to additional language structures” such as “I hope to get a par”, “it is important to make this shot”, “it is necessary to not go out of bounds”, etc.

In another embodiment, another component is added to the expanded language and shot cycle in the lower stage in FIG. 7. OK is another component (FIG. 9). A language goal of the component “OK” is to request permission and to return to the previous component. If the idea of the learner is changed by the new component or after an error, the learner can navigate the game better. Therefore, the game is made further complicated but more interesting. The OK before the start component can be used as follows. Is it OK to start? The OK can be used after the direction component or the club component and changes the game play.

In another embodiment, in order to expand the language and shot cycle, a general language component such as “talk” is added and expands the language and shot cycle. A merit of this general label is that some language structures cannot be simplified into one phrase. To talk can be used to talk about the hole at the end of the language and shot cycle. Talk component: A distance from the ball to the hole is 180 yards, for example. No. 7 iron club range: 140 to 100 yards. Question: Is the shot too far for the No. 7 iron? Yes, it is too far for the No. 7 iron.

Moreover, at an arbitrary step in the shot cycle, general conversation (Talk label) may be inserted.

In another embodiment using the talk component, to talk can be used before each component with a goal of giving advice relating to the direction: “Would you possibly want to go to the right?”

In the upper stage in FIG. 7, the language and shot cycle ends with the “club” and in the lower stage in FIG. 7, it ends with the “distance” since the shot is hit after the “distance” in the language and shot cycle. Since the language is used with the purpose of making a shot, the both are natural end of the cycle. After the shot, it is the climax of the game, and it is natural to finish the end of the game cycle and thus, to end the language and shot cycle.

In another embodiment, when the learner stops talking about the shot, the natural end of the cycle can occur, but it is “continuation” time and can be also used for an end point of the shot cycle.

In another embodiment, the language feedback can be made after each cycle, each hole, or hole group.

In another embodiment, the language and shot cycle can be a tool for parents to teach a child who has just begun talking the first language in their native language.

In another embodiment, concerning the language and shot cycle, an object can be moved around the board by using a dice or another object having numerals instead.

In another embodiment, the language and shot cycle can be a software program and enables networks of learners all over the world to form a social network and the foreign language learners to connect to it and learn and play together. In the social network, a sponsor can fund their logo and the like used in the game field. Moreover, a question concerning the sponsor (using the language of the device) can be used in a profit model. The learner can earn points by answering the question concerning the sponsor as collaboration between the sponsor and the learner. For information of the sponsor, a game maker has another source of income.

In another embodiment, the problem of the language and shot cycle can be used to ask a question relating to the player, the club, or the golf brand. Answers to these questions can be used for collecting marketing information relating to the brand.

In an application for a computer or a smartphone having a banner advertisement, the language from the content card can be used for negotiation with the banner advertisers or a game sponsor.

The banner advertisement on the application by the sponsor can be used in this device. The language used in this device can be used in various advertisements and banners. In another embodiment, the language and shot cycle can be used for navigating a monopoly type of a game.

In another embodiment, the language and shot cycle can be used for navigating between stages on the board. The language and shot cycle does not have to be used in an activity/operation screen of the game.

In another embodiment, the language and shot cycle can be used in a role-playing game.

In another embodiment, the language and shot cycle can be used in a shooting game.

In another embodiment, if the distance or movement is the same at all times or if the game uses a constant motion such as Pac Man, the language, and shot cycle may be only the “direction”. That is, in the language and shot cycle, at least either one of the moving direction and the distance of the piece is determined.

In another embodiment, after the language and shot cycle, each player draws a card from a set of “fight cards” and the players turn the cards upside down. It may be so configured that the player having the card showing the highest number wins the card, while the other players lose power. This may be use by a relative comparative language content card.

### (7) Expansion of Language and Shot Cycle: Replacement and Expansion of Language (FIG. 12)

Concerning the language and shot cycle (direction component and club component), there are a large number of language types (words, grammatical tenses or idioms or expressions) in each component. An upper part in FIG. 12 illustrates that language replacement is possible in the language and shot cycle but it is not limited to an example in FIG. 12. Since the meaning of the component is intuitive and the system enables easy replacement of phrases, the learners can increase their language knowledge quickly and easily as illustrated in the upper part in FIG. 12. Since many learners have a problem in increasing vocabulary in expressing the same thing, this system is extremely useful. The replacement effect can be used for the learners who need to increase the vocabulary quickly for tests such as TOEIC or TOEFL.

Each language may be replaced by support information such as labels (widely used symbols such as “!”, “?” and the like and signs), the native language of the learner, symbols expressing emotions (emoticons), intuitive symbols and the like. Moreover, each language may note such support information.

In one embodiment, many content cards can be used at the same time, and use of the various content cards can be used to deceive the other learners as a pitcher deceives a hitter by various kinds of pitching. By inserting a content card learned before by a current card, review can be made more interesting.

In another embodiment, the language and shot cycle can be expanded within the component as illustrated in the middle of FIG. 12 and can further challenge the learners as illustrated in the middle of FIG. 12.

### (8) Two-Part Question

In one embodiment, a first question can be designed to require a second question. For example, the “talk” component can be used together with the “club” component as follows. “Is it too far to use the No. 3 iron from here?”, “Yes, it is too far.”, “What club are you going to use?”, “I am going to use the No. 5 iron”. In another example, a two-part question can be used, and the game is made more accurate by three power options. Strong, average, and weak: What club do you want? I want the No. 4 iron card. Which No. 4 iron card do you want? I want a middle-strength card.

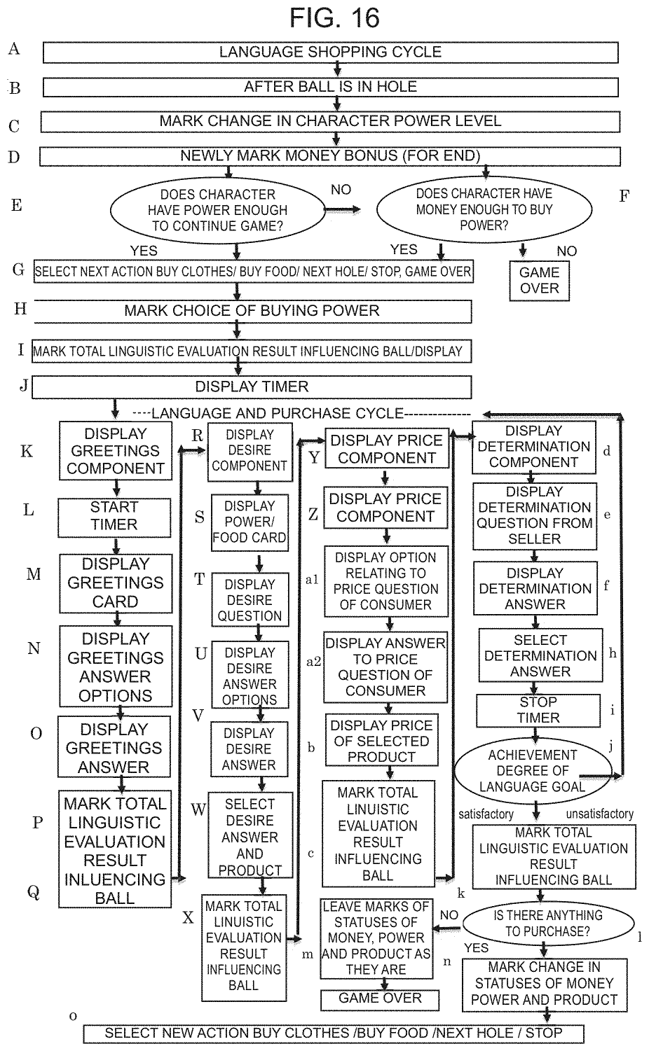

### (9) Language and Shopping Cycle (FIG. 16)—(Supported by Language and Shot Cycle) Another Patterned Speaking Structure for Shopping Power or Other Products

Another embodiment is illustrated in FIG. 16. A bonus to frequent playing is money bonus. As the player plays, the player loses power. The learner should buy power by money. Instead of buying power without using the language, the learned language is used in the structured role-playing again, and shopping and buying the power is talked about. This cycle is called a “language and purchase cycle”. This enriches the learning experience and increases repetition.

The “language and purchase cycle” is made of components having language goals as in the “language and shot cycle”. The learner sequentially learns through these components by using the language from the content card in the question and answer and acts through latent purchase from the start to the end. The content card can have the same basic grammar as that of the language and shot cycle, but the other cards need to be designed for a new speaking goal in the language and shopping cycle in some cases.

Language repetition leads to learners turning off their brains and translating from the mother language to the target language. Without repetition, learners progress slowly and lack confidence in their skills. This leads to a decrease in motivation or giving up language learning. However, language learning with a lot of repetition can be boring so a strict repetition method focused on language may not be optimal. The solution to this is making repetition fun by merging language repetition with language practice. According to one aspect, the design of the game is for an average of 3 shots/per hole will result in practicing the target language in question and answer 6 times. Moreover, this is done in a true game environment, so repetition is not represented or boring. If the learner takes 4 shots the practice becomes 8 times.

The language used in the club component and the direction component are the base of the language and shot cycle. The language of these components may be used in 18 holes of a level. As mentioned, 3 shots will result in using the language 6 times by 18 holes resulting in 108 times of using the language. In one level proficiency of the language may be achieved. In this game all the fundamental grammar tenses and other linguistic components may be addressed.

When the learner finishes a hole, the target number of shots may be 3 per hole and the minimum number of components (with the target language) may be 2. As a result, the learner will practice the language at least 6 times per hole. The adjustments may be made to the automated difficulty scale, if any, after the hole may be finished as adjustments in the middle of the hole would be unfair in game play. Also, level changes to quickly could make the learners think about levels instead of focusing on learning.

This amount of practice is necessary for languages that are very different from English. Language learning is very problematic when language learners are learning English and its subject verb object structure vs. subject verb object in Japanese. Furthermore, in English the first word of the sentence has more meaning in contrast to Japanese where the last word of the sentence is most important. These problems plus the origins of the language coming from Asia for Japanese and English from German and Latin, make them phonetically very different and thus, requires a considerable amount of time to become proficient.

In this embodiment, the “language and purchase cycle” is made of greetings, desires, prices, and determination. The learner starts at the “greetings component” and ends at the “determination component”. The greetings component is a basic method of practicing various greetings at shops. The question and answer relating to the greetings may be Hello, can I help you?/Yes, please or the like. The desire component is a basic method for practicing expression of a customer's desire at a shop. The question and answer relating to the desire may be Would you like some drink?/Yes, please or the like. The price component is a basic method for practicing various questions for asking the price. The question and answer relating to the price may be How much is it?/3 dollars or the like. Moreover, after the teacher's question “Do you know the price?”, the student's answer may be “No, I don't.”. Subsequently to that, a question “How much is it?” may be made by the student, and an answer “3 dollars.” may be made by the teacher. The determination component is a basic method for practicing transmission of determination to the shop. The question and answer relating to the greetings may be Determination: Do you want this?/Yes, I want it or the like.

In another embodiment, the power can be replaced by a health level, and after the language and shot cycle, the pattern language structure (language and health cycle) can be used for visiting a doctor or a drug store.

In another embodiment, the order of these components can be changed or increased.

In another embodiment, another component or preference is added for the student to express an emotion. The preference is also used for asking a question relating to products: shopping, clothes, golf clubs and the like. This data can be collected as research in documents or by using a program on the Internet.

In another embodiment, another component, desire is added for the student to express the desire of buying a product. The desire can be used for asking if the student wants the product concerning the product: shopping, clothes, golf clubs and the like. This data can be collected as research in documents or by using a program on the Internet. That can be means for connecting the game to a banner advertisement or a sponsor page.

In another embodiment, options of clothes relating to the character, products, foods and the like can be used for understanding preference of the learner. This information can be used for making better advertisement or targeted advertisement.

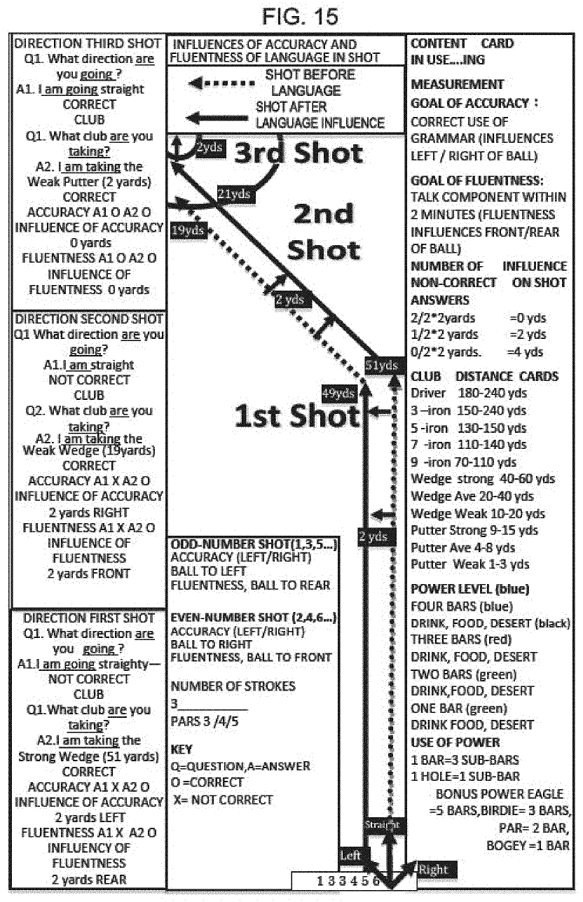

### (10) Influence of System Structure and Language on Shot (FIG. 15)

### (10-1) Play Surface (Game Field)

The play surface is a golf course, and a rectangle overlapped on it makes easy navigation and easy movement of the shot in accordance with the selected direction and shot card. A start location is a location where the first shot is made in the lower part of the surface. The student selects a start location. This selection does not need a conversation. A large black circle on the upper left is a hole or a finish. There are six rectangles in the circle in order to facilitate the game play.

In another embodiment, the course may be made by other geometric shapes such as a circle and an octagon.

In another embodiment, in addition to the board game, the system can be used in a role-playing game, a video game, and a video game between two users in different regions or point-to-point in browser.

In another embodiment, various locations on the course such as a fairway not influencing the ball and rough giving a bad influence to the ball to front/back/left/right based on a rough card. This card is taken after landing on the rough, and the ball is moved at random in accordance with the card.

In another embodiment, there can be one or more finish circles.

In another embodiment, the location on the surface can have a miscellaneous language question by which remuneration can be gained.

In another embodiment, the golf course is associated with a grid of 18 holes having a shop, a hospital, a parking lot, an airport, and other locations on the board. The other locations are for expanding use of the language by the other language cycles in the language and shot cycle.

In another embodiment, the game may be played on a huge play mat used in a nursery school, a kindergarten and the like instead of a board, and the card or a huge dice may be used for navigating the piece such as a ball.

### (10-2) Arrow Given to Ball

In order to navigate the course and to select the best direction, an arrow is given to the ball. There are left, straight and right arrows. A direction label on the arrow makes direction and language learning more intuitive.

In another embodiment, these language tips on the arrows can be removed.

### (10-3) Club

The club is displayed on the lower right, and the player selects the best club in order to make stroke amount the lowest from the start to the end.

In another embodiment, in a role-playing game such as “DUNGEONS AND DRAGONS”, a dice can be used instead of moving the ball in another game.

### (10-4) Symbol List

A symbol list has some important abbreviations: A indicates an answer, O indicates a correct answer, X indicates a wrong answer, and Q indicates a question. Concerning each language and shot cycle, there are a club component and a direction component. The both have the questions (Q) and answers (A). A question No. 1 is abbreviated as Q1, an answer NO. 1 is abbreviated as A1 and the same applies to thereafter. Recording to the results can be made as in FIG. 8.

### (10-5) Measurement

The language goal uses the current progressive-form language card (ING). The language is measured in terms of accuracy and fluentness. Both the accuracy and fluentness influence the ball. The goal of accuracy is, as defined in the content card, use of the correct grammar both in the direction card and the club card.

In another embodiment, the accuracy can be measured by various methods. For example, measurement of the language accuracy, measurement of a language usage, measurement of language politeness or measurement of language pronunciation is included. The language accuracy can be measured with respect to the database of the content card on the computer or the content card on a hard drive.

In this figure, the goal of the fluentness is to finish each component in 2 minutes or less and measurement relating to both the direction card and club card by a stop watch. For each answer which has not achieved the goal of the accuracy or fluentness, the 2-yard penalty is imposed on the shot. In another embodiment, the ball can advance a distance other than 2 yards concerning each error. The first, second, and third shots: A broken line indicates a beginning shot, and a gray line indicates influences of accuracy and fluentness to the shot.

In another embodiment, an error can be added to a total score of the shot at the end.

In another embodiment, it may be so configured that the shot is influenced favorably by use of a language and a penalty is not imposed.

In another embodiment, the question may be a practice of the expression or may have multiple-choices. Whether the expression of the question is appropriate or whether the correct option has been selected is tested, and the result can influence the ball.

In the figure, the influence of the language on the ball, left or right and rear or front can be made by the number of shots which is an odd number or an even number.

In another embodiment, only the variable of either one of the accuracy and the fluentness can influence the shot.

In another embodiment, the bundle of cards can make the effect of the language on the shot at random. By means of the bundle of cards, the progress of the ball according to the accuracy and the fluentness is made at random.

In another embodiment, the result of neither of the fluentness nor the accuracy influences the shot. In this case, too, the ball is moved in an unpredictable way due to the shot card and the direction selection.

In another embodiment, the goal of the fluentness is set by selecting time required for completing the language and shot cycle and is described on the upper part of FIG. 8. When the fluentness is to be measured, it can be set and measured for each component or all the shot cycles.

In an embodiment of another game play, the accuracy and the fluentness or other variables can be used and influence the final score of the hole without influencing the shot.

In another embodiment, the penalty can be imposed on the shot by a poor play only after some language errors are made.

In another embodiment, the remuneration can be given to a shot by a useful shot and game play only after some correct answers are made.

In another embodiment, the learner can be required to take a penalty card after the language and shot cycle relating to a poor language result and the penalty is imposed on the shot in accordance with the card.

### (10-6) Power Level

The power level indicates a power amount the player currently has. The power is given by a bar. Each bar has three sub-bars made of drink, food, and dessert. The player starts the game by two bars as illustrated by the two green bars. Use of the correct language and favorable golf play give a low score. The low score is given remuneration by the power bars as follows: Eagle=5 bonus bars, birdie=3 bonus bars, par=2 bonus bars, bogey=1 bonus bar, double bogey=0 bonus bars.

Concerning this hole, it was three pars (indicating that you need to reach the hole in 3 strokes). This is marked by blue 3 in the middle of the list. By means of the power remuneration system, the learner gained a power bar as indicated by a red bar. As the power use system (dessert was arbitrarily exhausted) one sub-bar was exhausted concerning the hole and thus, one sub-bar is subtracted so as to be seen by a black sub-bar.

Each hole needs one sub-bar and thus, the player can play six holes by two green bars. If the player does not gain a bogey within the first six holes, the power is used up, and the game is finished. Limitation on the power means that motivation is further given to the language learner in order to achieve the proficiency level.

In another embodiment, the sub-bar can be changed from the power to money, and the learner collects money and buys the power in the language and shopping cycle.

In an embodiment of another money remuneration, extra money the player gains can be used for buying more power, a golf club or golf-wear. The club or the wear is useful for the golf play or gives more bonus points.

In another embodiment, the player can use money for buying better-quality food, and the food has a favorable influence on the ball.

In another embodiment, the language and game play can be used as means for performing a linguistic preparation exercise and for making preparation for using the language in other documents, a role play, or a language program.

In another embodiment, the smaller power bars the learner has, the more desperate the shot should be. Therefore, an additional penalty card can be added to the language result of a predetermined power level. As a result, the learner is made to perform more role-playing for buying food. If the power level is low, the accuracy or the fluentness has an influence, and its random effect can be increased. As a result, the learner's interest in using the shopping cycle is increased.

In one embodiment, the result of a shopping role-playing language can be added to the language and shot cycle.

In another embodiment, this system can be easily set up similarly through the network, and the players play at the same time all over the world such that one of the players asks a question, and the other player answers the question. The language is replaced in order to reach a goal such as in Englishtown (U.S. Pat. Nos. 6,741,833, 7,058,354) and Rosetta Stone (U.S. Pat. No. 7,524,191). However, these patents do not focus on language replacement.

Furthermore, this language device is incorporated in a speaking device such as Skype for connecting the teacher and the learner or the learners.

In another embodiment, the results of the accuracy and the fluentness can be indicated by power bars instead of X or O in the list. If the results of the accuracy and the fluentness are perfect, the power bars are 100%.

In another embodiment, it may be so configured that evaluation results on two players (an evaluation result of at least one of the question and answer) influences the ball or the evaluation result (evaluation result of at least one of the question and answer) on one of the players influences the ball.

In another embodiment of two players, the language results of the two players can be compared, and positive results of the both, negative results of the both, a difference in the results of the two players, and a best result of the two players can influence the played ball.

In another configuration of the two players, both the accuracy and the fluentness, only the accuracy or only the fluentness influences the language result of the configuration of two players.

In another, the teacher or the computer can replace one language learner. In this situation, the computer plays a role of a counterpart of the language learner.

In one embodiment, the computer may ask questions and make answers by an influence of the language to the game without playing the game.

In one embodiment, the teacher or the computer plays the game, competes with the student and makes an error in the answer, whereby another answer as correct as possible is shown to the learner.

In another embodiment, it may be so configured that the play is made alternately depending on intensity of the learning or one player plays until the ball drops in the hole and then, it is determined whether another person will play or not. The latter also helps consistent repetitious practice of the learner.

In another embodiment, the language goal may be an advice before a component of the language and shot cycle. In this case, the questioner may be a type of an instructor or a coach of an answerer/shooter. If the language or its use of the questioner is good, the result can influence the answer/shooter or they can influence the shot in the next play. Moreover, in an appropriate step of the shot cycle, the questioner can give an advice to a shooter. This advice (ADVICE COMPONENT) may be expressions such as “How about . . . ?”, “Why don't you . . . ?” and the like. Moreover, a general conversation may be inserted in the shot cycle as appropriate.

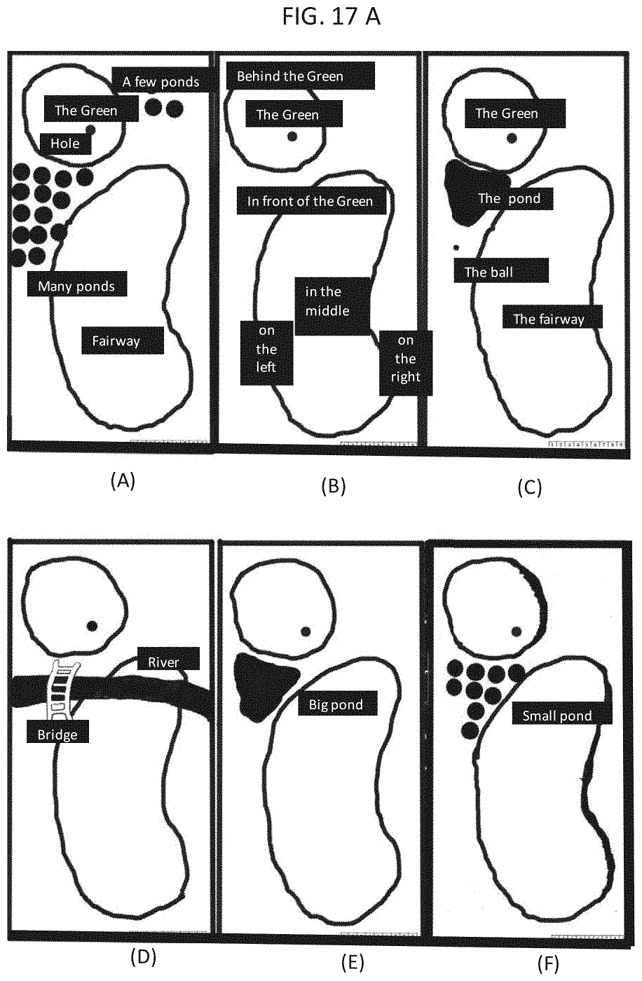

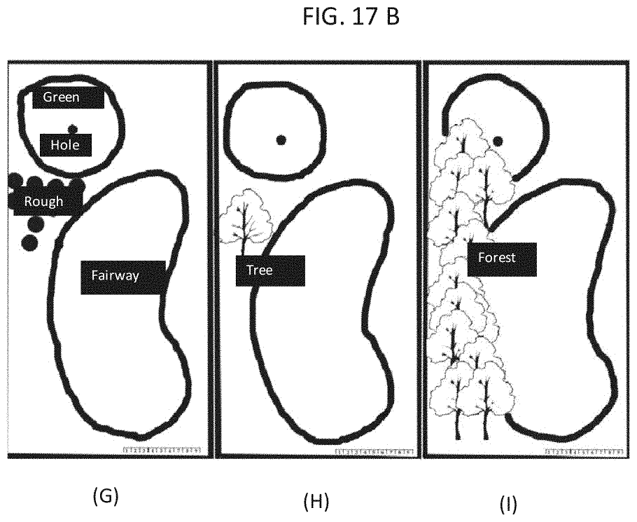

### (11) Introduce More Languages by Course Design (FIG. 17A and FIG. 17B)

To add a new object on the course can increase vocabulary of the student. Addition of intuitive objects, such as a tree, a forest, a pond, a big pond, a bridge, a list of animals in rivers, fruits, vegetables, mushroom, a snowman, or of objects known all over the world to the game can expedite learning. If only one object is introduced once, the learner can estimate association between the new object and the language quickly. For example, if the ball is near a big pond, and the big pond is only the new object and the other game objects are known, the student can associate the word of the large pond to the object.

In one embodiment, with the purpose of easy language introduction, multiple-choices indicate new and known languages and are good at comparing them and thus, the multiple-choices can be used in the question and answer. In addition of seeing a new language in the game, the learner can associate the new language and the new objects by a learner who is watching the new language in the multiple-choices.

FIG. 17A and FIG. 17B illustrate another embodiment of the language introduction. A label on the course near the new object associates the language with the vocabulary. By placing the label of a new word “Big pond” on or near the object, the learner can estimate that the new object is a big pond. This enables understanding of the language by the learner without spending time in the language introduction.

In another embodiment, before the new object is added to the course and before the game play, practice can be made before a flash card having the new object adds the object to the language and shot cycle. Moreover, the flash card can be supported also by the language label added to the course.

In a future embodiment, through a support of a computer and a touch screen or a click, the learner can show the card, the word, and the meaning by clicking a golf screen for the new object.

In one embodiment, the language and the object used by the learner can control progress of the game. For example, in a conversation in the shot cycle, if an answerer answers “I am aiming for the tree”, the ball is directed to the direction of the tree or the like.

In another embodiment, use of a golf surface such as a tunnel which is not traditional and an object such as a mystery card gives another language option for increasing the learning and the game play.

In another embodiment of a non-ordinary surface, the role-playing can be incorporated in a special space under the “talk” component. One or more spaces are based on themes such as weather. The space can have an icon like autumn. The learner selects an answer for depicting the autumn weather as follows in a mini role-playing: How is the weather? A cold, B cool, C hot. What is a temperature? Approximately A 0 to 10 degrees Celsius, B 10 to 20 degrees Celsius, C 20 to 30 degrees Celsius.

Another embodiment is a course design not using traditional golf objects and obstacles. The game can have a tunnel to be given to the learner, a weather object or mystery card, learn new words, and use various vocabularies.

In another embodiment, the course may be a movable obstacle or hazard. In one situation, the obstacle may be an animal which can be placed on the course, and they are moved during the game play and are incorporated in the game play and the language learning.

In another embodiment, the “talk” can be used to incorporate speaking in the game. For example, talk—question: What is that? Answer: That is a pig. That is a giraffe. That is a snake. Talk: question—What is the snake doing? Answer: It is biting, it is eating, and it is swimming. In each game play after the language and shot cycle, a movable object can make one movement at the same time or at one time to left, right, front or rear in accordance with a set of cards relating to animals. Moreover, the animal may be a special hazard and may give additional points or end the game.

### REFERENCE SIGNS LIST

10 operation portion, 12 speaker, 14 microphone, 16 display portion, 18 device body portion, 20 question providing portion, 22 answer recognition portion, 24 execution portion, 26 image generating portion, 28 storage portion, 30 direction content card, 32 club content card, 34 club distance card, 36 game field, 38 piece, 40 evaluation sheet, 42 goal region, 44 start position.

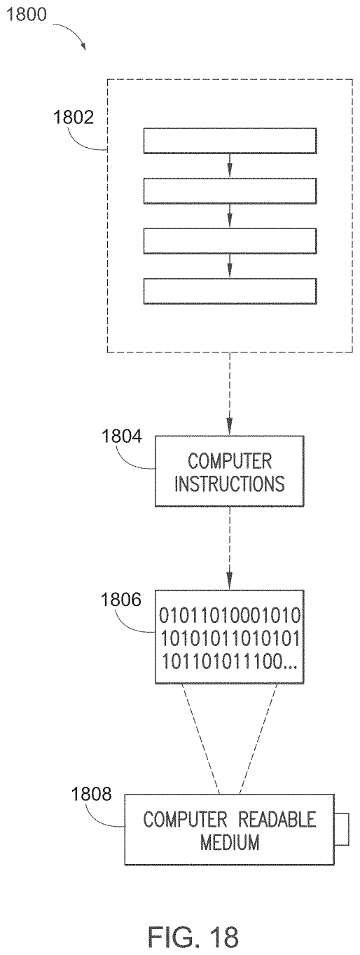

Still another aspect involves a computer-readable medium including processor-executable instructions configured to implement one aspect of the techniques presented herein. An aspect of a computer-readable medium or a computer-readable device devised in these ways is illustrated in FIG. 18, wherein an implementation 1800 includes a computer-readable medium 1808, such as a CD-R, DVD-R, flash drive, a platter of a hard disk drive, etc., on which is encoded computer-readable data 1806. This encoded computer-readable data 1806, such as binary data including a plurality of zero's and one's as shown in 1806, in turn includes a set of processor-executable computer instructions 1804 configured to operate according to one or more of the principles set forth herein. In this implementation 1800, the processor-executable computer instructions 1804 may be configured to perform a method 1802, such as the method of FIG. 5. In another aspect, the processor-executable computer instructions 1804 may be configured to implement a system, such as the system or device of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

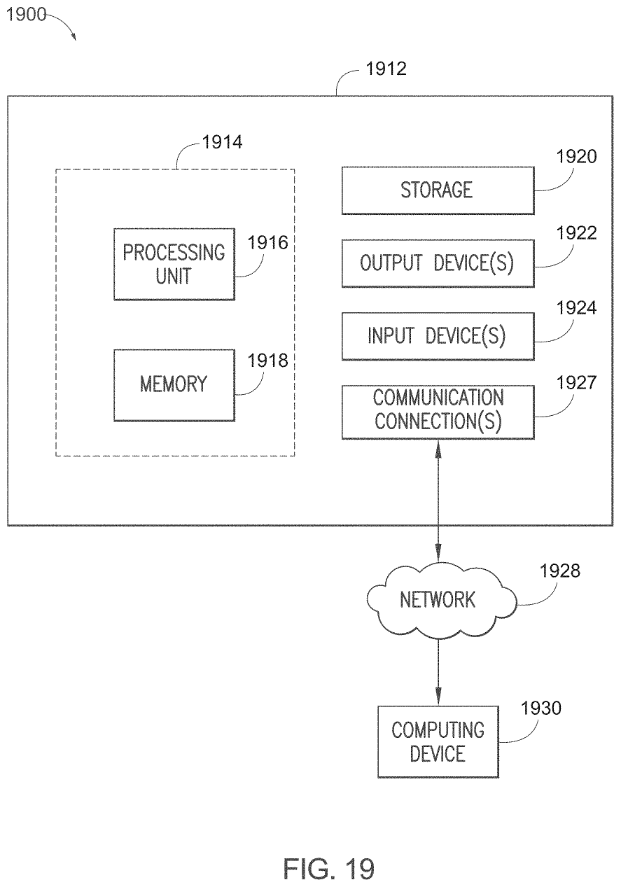

FIG. 19 and the following discussion provide a description of a suitable computing environment to implement aspects of one or more of the provisions set forth herein. The operating environment of FIG. 19 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as may be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 19 illustrates a system 1900 including a computing device 1912 configured to implement one aspect provided herein. In one configuration, the computing device 1912 includes at least one processing unit 1916 and memory 1918. Depending on the exact configuration and type of computing device, memory 1918 may be volatile, such as RAM, non-volatile, such as ROM, flash memory, etc., or a combination of the two. This configuration is illustrated in FIG. 19 by dashed line 1914.

In other aspects, the computing device 1912 includes additional features or functionality. For example, the computing device 1912 may include additional storage such as removable storage or non-removable storage, including, but not limited to, magnetic storage, optical storage, etc. Such additional storage is illustrated in FIG. 19 by storage 1920. In one aspect, computer readable instructions to implement one aspect provided herein are in storage 1920. Storage 1920 may store other computer readable instructions to implement an operating system, an application program, etc. Computer readable instructions may be loaded in memory 1918 for execution by processing unit 1916, for example.

The term “computer readable media” as used herein includes computer storage media. Computer storage media includes volatile and nonvolatile, removable and non-removable media implemented in any method or technology for storage of information such as computer readable instructions or other data. Memory 1918 and storage 1920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 1912. Any such computer storage media is part of the computing device 1912.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 1912 includes input device(s) 1924 such as keyboard, mouse, pen, voice input device, microphone, touch input device, infrared cameras, video input devices, or any other input device. Output device(s) 1922 such as one or more displays, speakers, printers, or any other output device may be included with the computing device 1912. Input device(s) 1924 and output device(s) 1922 may be connected to the computing device 1912 via a wired connection, wireless connection, or any combination thereof. In one aspect, an input device or an output device from another computing device may be used as input device(s) 1924 or output device(s) 1922 for the computing device 1912. The computing device 1912 may include communication connection(s) 1926 to facilitate communications with one or more other devices 1930, such as through network 1928, for example.

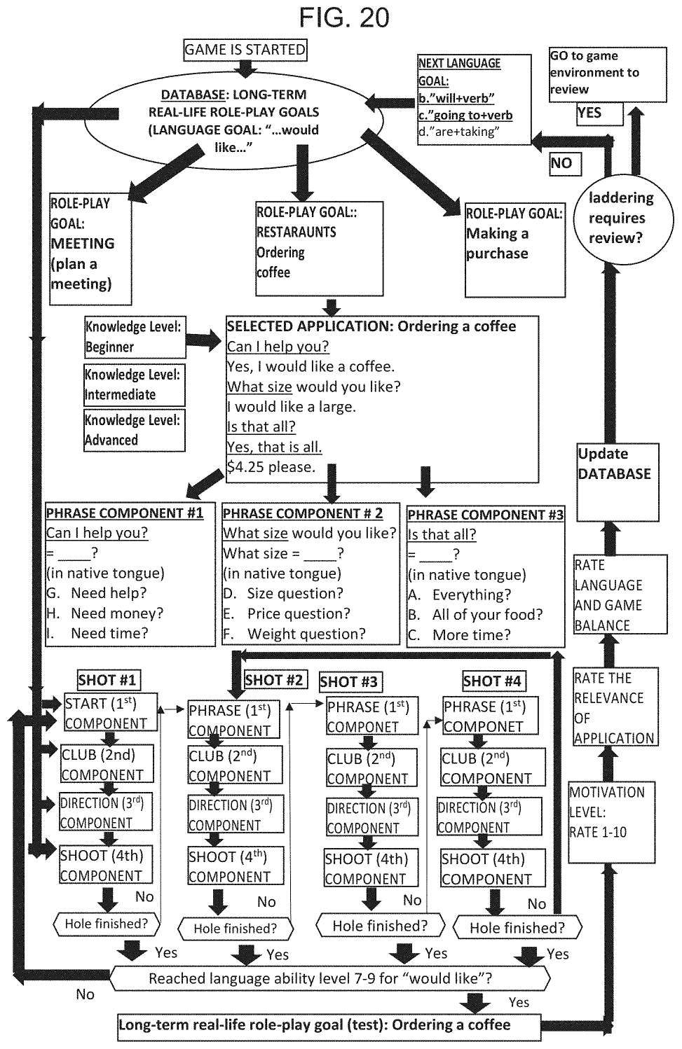

In FIG. 20, the game's linguistic goal is using “would like”. Next, the learner chooses how to study “would like” in the long-term real-life role-play goals. The learner has three choices: “would like+planning a meeting”; would like+ordering coffee”; and “would like+making a purchase. In this case, the learner selected “would like+ordering a coffee”. The computer will then prepare a conversation such as the selected application: ordering a coffee. Also, as the learner has a beginner knowledge level the language will be tested with simple linguistic tests.

In the game, the learner will use the target language “would like” to move the ball with the club component, the direction component, the shoot component. In the selected application some of the words, phrases or linguistic concepts from “ordering a coffee” that are not naturally put into gameplay are underlined and prepared as phrase components. The underlined phrases will be tested like phrase components cards #1,#2,#3. They will be added to the language and shot cycle and the language in the phrase components and prepare the learner for the long-term real-life role-play goals. The learner will play the language game for several holes with the phrase components until the language ability of level 7-9 with the automated difficulty adjustment making the necessary changes to maintain motivation. After the learner reaches level 7-9, the learner will be able to go to the long-term real-life role play goals and practice ordering a coffee. After the practice goal of learning a coffee the learner can give feedback for the relevance of the application for further system improvements and rate the language game balance for further improvements to the system and programs. If the learner has passed the long-term real-life role-play goals the learner can move to the next language goal and choose roleplays that motivate the learner. In this case the next language goals is b.“will+verb”. If the learner does not pass the long-term real-life role-play goals, the algorithms will place the learner in the game environment again and it will use laddering techniques to address the failure until the learner can use the “would like” and the phrase components to order a coffee. After the learner passes the “ordering a coffee”, the learner can move to the next language goal:b. “will+verb”.

Also, the transition from language and game to real-life language goals is part of laddering: “Anytime students take steps down the ladder, teachers intervene with new instructional strategies to move them back up rather than down each step represents a small segment of instruction that helps students achieve the final learning goals. They see how the first step connects to the second step and so on”.

In beginner knowledge level, the learner learns how to move the ball with basic grammar and linguistic structures: will+verb (will+take); verb. +ing (taking); +going to verb(going to take) In addition, the learner will also see how they would like and want can be substituted without a problem, much the same as substituting “I will take . . . ” with “I am going to take . . . ” and “I am taking . . . ”. In addition, the learner is able to move the ball will and see language substitution with linguistic structures: want to (take); would like to (take); will have; going to take.

FIG. 21 is a view illustrating a plurality of types of questions associated with a content card for ordering coffee.

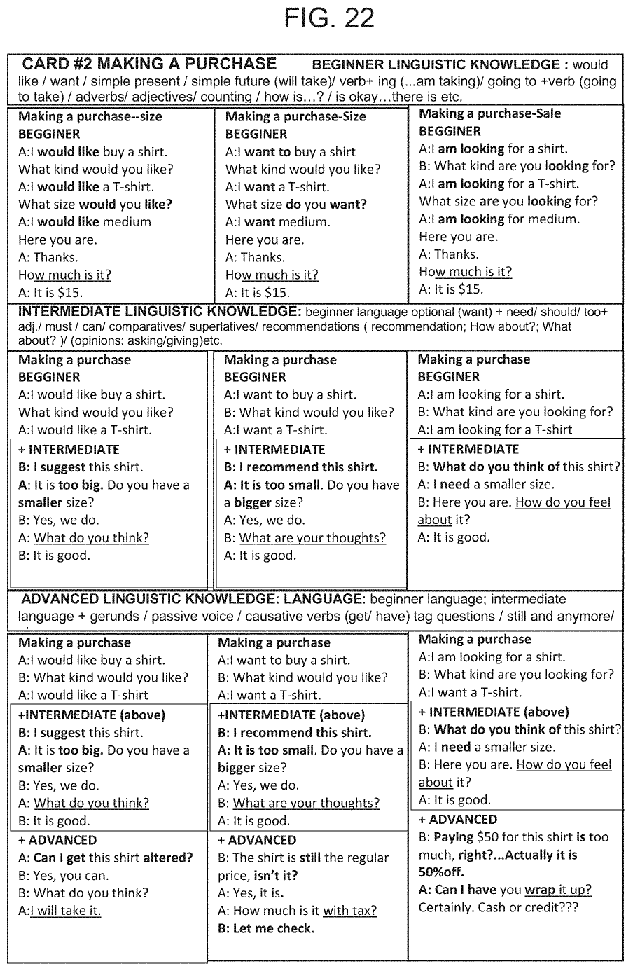

FIG. 22 is a view illustrating a plurality of types of questions associated with a content card for making a purchase.

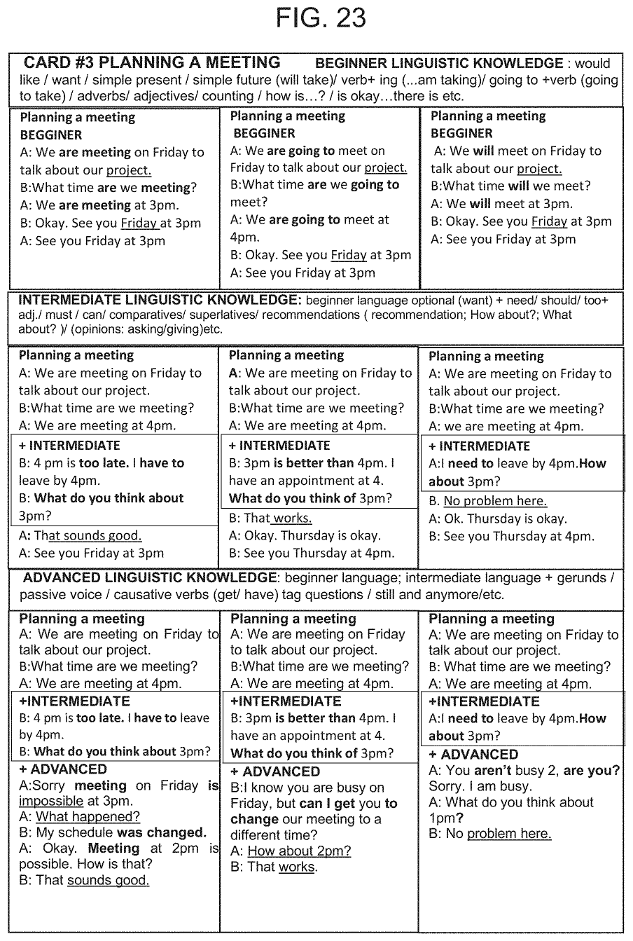

FIG. 23 is a view illustrating a plurality of types of questions associated with a content card for planning a meeting.

In the beginner level, the learner, sees how substitution of basic linguistic tools for moving the ball. After playing, the learner has experiences according to constructivism that are necessary to perform real-life long-term language goals in Card #3 of planning a meeting. In addition, the underlined words of Card #3 are used in the language and shot cycle. These words are tested in the word component, where the learner practices vocabulary through multiple-choice.

When the learner is doing the long-term real-life role-play part of the language goal, the learner can be tested by physical input (touch screen) or voice input (voice recognition). The learner will be judged by an accuracy only because the narration (of the other character) is set at the narration speed of the beginner speed. The expected accuracy for physical and voice input versions are set at 70% as per gaming rules. As in the game, there is a challenge button and the learner can use it for 80% of the conversation. Moreover, the data is collected to improve the pronunciation profile and linguistic knowledge of the learner to help them reach their goals, keep motivation, and improve the system by machine learning. If the language learner does not meet the language goals, the educational concept of “laddering” will be used. But instead of a teacher making adjustments to the curriculum in laddering, the algorithms will make the necessary adjustments.

Instead of a teacher finding the weakness and mistakes, the system will be configured for laddering by a computer and adjust the level of the student to the correct level based on the concept of the learner as in FIG. 20. When a weakness is discovered, instead of practicing without a relevant goal, the algorithm implemented via the processor of the device may configure the game to focus on the weakness and then bring the learner back to the real-life language goal after the learner reaches level 7-9 in ability levels.

In the intermediate level, the learner, when using language to play the game, the learner sees how other that language compliments the beginner level: need/should/too+adjective/must/can/comparatives/superlatives/recommendations (recommendation; How about? What about?); opinions (giving/asking). After playing, the learner has experiences according to constructivism that are necessary to perform real-life long-term language goals better in Card #1, #2, and #3. Moreover, in the real-life long-term language goals, beginner language is again used (using laddering concepts), thus reinforcing past learned language goals. Although not shown, this grammar and linguistic tools can be set up in a patterned conversation as the beginner section. The language constructs used in the game make the long-term real-life role-play goals more lifelike. In the intermediate part of the dialogue, the learner can deal with problems (suggestion language); explain a problem (too+adj); get and give an opinion; deal with comparatives and superlatives.

In addition, the underlined words of Cards #1-3 are used in the language and shot cycle. These words are tested in the word component, where the learner practices vocabulary through multiple-choice.

When the learner is doing the long-term real-life role-play goals as in CARD #1, #2, #3, the learner can be tested by physical input(touch screen) or voice input(voice recognition) in the same way as the beginner level, however, the narration speed in the intermediate language-game increases, thereby the narration speed increases at the next level. The game and linguistic data is logged and used for further improvements, however, if the learner is having problems with problems in the beginner or intermediate language level and the learner does not meet the 70% threshold for either, the learner will have to play the game to the requisite 7-9 language ability to get back to the real-life language goals and test again before moving on to the language goals.

In the advanced level, the learner, when using language to play the game, the learner sees how other that language compliments the beginner and intermediate level: gerunds/passive voice/causative verbs (get/have) tag questions/still and anymore/. After playing, the learner has experiences according to constructivism that are necessary to perform real-life long-term language goals better in Card #1, #2, and #3. Moreover, in the long-term real-life role-play, beginner language is again used (using laddering concepts), thus reinforcing past learned language goals. Although not shown, this grammar and linguistic tools can be set up in a pattern conversation as the beginner section. The language constructs used in the game make the long-term real-life role-play even more lifelike. In the advanced part of the dialogue, use or react gerunds, pass voice, causative verbs and tag questions, which will help them integrate into society easier.

In addition, the underlined words of Cards #1-3 of FIGS. 21-23 are used in the language and shot cycle. These words are tested in the word component, where the learner practices vocabulary through multiple-choice.

When the learner is doing the long-term real-life role-play, the learner can be tested by physical input(touch screen) or voice input(voice recognition) in the same way as the beginner and intermediate level, however, the narration speed in the advanced language-game increases, thereby the narration speed increases at the next level. The game and linguistic data is logged and used for further improvements, however, if the learner is having problems with problems in the beginner, intermediate, or advanced language level and the learner does not meet the 70% threshold for either, the learner will have to play the game to the requisite 7-9 language ability to get back to the real-life language goals and test again before moving on to the language goals.

Furthermore, this system is very well constructed for further laddering of the basic linguistic concepts utilized in the beginner level, intermediate level, and the advanced level:

“Can” can be substituted with the following: able/possible/manage to

“Can” can be substituted with “Need”. For example, “Can you get a par on the next shot?” and “Do you need to make this shot for a par?” are a natural substitution.

“Need” can be substituted with the following: should/must/required/necessary etc.

“recommendation” can be substituted with the following: recommendation/suggestion/why don't you/how about . . . ?

Also, the cards #1-3 for long-term language goals, can be expanded immensely by changing nouns (meeting to party, gathering, get together, etc.); Shopping words (Is that all?; Is that everything; Will that be all for today?), adjectives (impossible to “not happening”, “no small task”) most popular (the coolest, the most fashionable, the hippest). In addition to this, the layering of levels for lot of beginner; beginner and intermediate; beginner, intermediate, and advanced gives endless permutations and combinations from just 3 cards. Of course, these cards are far from the complete database, but are used to show a long-term linguistic goal and that the language used in the game is to support the learner during the long task of becoming linguistically confident and proficient in both the active and passive use of language.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering may be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It may be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A language practice device comprising:
a question providing portion configured to provide a question to a learner in a language to be learned;
an answer recognition portion configured to recognize an answer to the question; and
an execution portion configured to execute a game based on a conversation process which is established by the question to the learner and the answer by the learner; and
a display portion configured to display an image in accordance with each process executed by the question providing portion, the answer recognition portion, and the execution portion,
wherein
the question providing portion and the answer recognition portion perform:
a process which proceeds a first conversation process for determining an advancing direction of a piece used in the game, and
a process which proceeds a second conversation process for determining an advancing distance of the piece,
the execution portion executes:
a process which determines the advancing direction of the piece based on a linguistic evaluation of an answer in the first conversation process,
a process which determines the advancing distance of the piece based on a linguistic evaluation of an answer in the second conversation process, and
a process which determines a position of the piece in accordance with the advancing direction and the advancing distance,
the display portion displays:
a field for indicating a progress state of the game by the position of the piece, and
a card selecting figure when the question providing portion provides the question,
the question providing portion provides a question corresponding to a card selected by the learner on an image including the card selecting figure based on a predetermined success ratio and a mental fatigue score determined based on based on a length of a language learning session, and
the execution portion executes the linguistic evaluation corresponding to the card selected by the learner on the image.

2. The language practice device according to claim 1, wherein
the display portion displays images of a first bundle of cards and a second bundle of cards as the image of the card selecting figure,
the display portion further displays an image indicating a front or a back of the card selected by the learner on the image,
on each of the card included in the first bundle of cards, a question or information for progressing the first conversation process, which is a question to the learner or information for identifying a predetermined question to the learner, is described,
on each of the card included in the second bundle of cards, a question or information for progressing the second conversation process, which is a question to the learner or information for identifying a predetermined question to the learner, is described,
on each of the card included in the first bundle of cards, information for the linguistic evaluation in the first conversation process, is further described, and
on each of the card included in the second bundle of cards, information for the linguistic evaluation in the second conversation process, is further described.

3. The language practice device according to claim 1, wherein
the display portion displays an image of a bundle of cards as the image of the card selecting figure,
the bundle of cards are common for the first conversation process and the second conversation process,
the display portion displays an image indicating a front or a back of the card selected by the learner on the image,
each of the card included in the bundle of cards describes,
a question or information for progressing the first conversation process, which is a question to the learner or information for identifying a predetermined question to the learner,
information for the linguistic evaluation in the first conversation process,
a question or information for progressing the second conversation process, which is a question to the learner or information for identifying a predetermined question to the learner, and
information for the linguistic evaluation in the second conversation process.

4. The language practice device according to claim 1, wherein
the execution portion executes a process for setting a power to be given to the learner based on the progress state of the game,
the question providing portion and the answer recognition portion execute
a process for advancing a third conversation process established in business transaction,
the third conversation process includes a question uttered by the learner in a case of purchasing a product according to the power and an answer uttered from a counterpart of the learner in the case of purchasing the product according to the power.

5. A storage medium which stores a language practice program for making a computer execute:
a question providing process for providing a question to a learner in a language to be learned;
an answer recognition process for recognizing an answer by the learner;
an execution process for executing a game based on a conversation process which is established by the question to the learner and the answer by the learner; and
an image generating process for generating an image in accordance with each of the question providing process, the answer recognition process, and the execution process, wherein
the question providing process and the answer recognition process configures,
a process which proceeds a first conversation process for determining an advancing direction of a piece used in the game, and
a process which proceeds a second conversation process for determining an advancing distance of the piece,
the execution process includes,
a process which determines the advancing direction of the piece based on a linguistic evaluation of an answer in the first conversation process,
a process which determines the advancing distance of the piece based on a linguistic evaluation of an answer in the second conversation process, and
a process which determines a position of the piece in accordance with the advancing direction and the advancing distance,
the image generating process includes
a process for generating a field image for indicating a progress state of the game by the position of the piece, and
a process for generating an image of a card selecting figure, which is a process executed when providing the question in the question providing process,
the question providing process includes a process for providing a question corresponding to a card selected by the learner on the image including the card selecting figure based on a predetermined success ratio and a mental fatigue score determined based on based on a length of a language learning session, and
the execution portion includes a process for executing the linguistic evaluation corresponding to the card selected by the learner on the image.
